(19) United States
(12) Patent Application Publication
(10) Pub. No.: US 2026/0299564 A1
(43) Pub. Date: Oct. 1, 2026

(54) PREDICTIVE CONTROL SYSTEMS AND METHODS FOR MODULAR SYSTEMS

(71) Applicant: Imubit Israel Ltd., Modiin (IL)

(72) Inventors: Elhanan Ilani, Jerusalem (IL); Netanel Moyal, Be'er Ganim (IL); Naama Kochva, Giv'at Shemu'el (IL); Nadav Cohen, Yavne (IL)

(73) Assignee: Imubit Israel Ltd., Modiin (IL)

(21) Appl. No.: 19/094,744

(22) Filed: Mar. 28, 2025

(51) Int. Cl. G05B 19/418

(52) U.S. Cl. CPC G05B 19/41845; G05B 19/4184; G05B 19/41885

(57) ABSTRACT

A modular control system for a plant includes a plurality of subsystem predictive controllers and a main controller. The subsystem predictive controllers are configured to operate corresponding subsystems of the plant to affect a plurality of controlled variables (CVs). The main controller is configured to execute a control process which includes adjusting a plurality of manipulated variables (MVs) including targets for the CVs and providing the MVs as inputs to the subsystem predictive controllers. The main controller is configured to detect an event that causes one or more of the CVs to become at least partially uncontrollable. In response to detecting the event, the main controller is configured to modify the control process to compensate for the event. The main controller is configured to execute the modified control process which includes adjusting a subset of the MVs and providing the subset of MVs as inputs to the subsystem predictive controllers.

### BACKGROUND

The present disclosure relates generally to predictive control systems and methods for monitoring and controlling modular systems or plants. A plant in control theory is the combination of a process and controllable equipment capable of affecting the process. A modular system or plant includes multiple interconnected subunits or subsystems with specific control needs. The subsystems may be connected to each other in various parallel and/or series arrangements. One example of a modular system is an oil refinery with multiple subsystems (e.g., a diesel hydrotreater subsystem, a fluid catalytic cracking subsystem, a hydrocracking subsystem, a coker subsystem, etc.) that operate in series and/or in parallel to perform various oil refinery processes.

Predictive control systems typically use a model of the plant to predict future states and optimize actions based on those predictions. One type of predictive control system which has been used to predict and control the behavior of oil refinery systems is a deep learning process control (DLPC) system. DLPC uses advanced neural network models to predict, control, and optimize the performance of the plant. For example, a DLPC system with a neural network controller and neural network predictor is described in detail in U.S. Pat. No. 11,200,489 granted Dec. 14, 2021, the entire disclosure of which is incorporated by reference herein. DLPC has been used to enhance efficiency, reduce operational costs, and maximize output by analyzing and learning over extensive process data, identifying patterns, and making precise adjustments.

However, modular systems introduce complexity in terms of communication delays, subsystem interactions, and chain of actions, all of which must be addressed for effective control. Implementing neural network models such as DLPC in real-world plants involves addressing challenges across multiple interconnected subsystems. Because changes in one subsystem can affect other subsystems, a comprehensive solution must consider the dependencies and interactions between subsystems to ensure effective coordination and optimization throughout the plant. The systems and methods described herein address such challenges.

### SUMMARY

One implementation of the present disclosure is a modular control system for a plant having a plurality of interconnected subsystems. The modular control system includes a plurality of subsystem predictive controllers configured to operate corresponding subsystems of the plurality of interconnected subsystems to affect a plurality of controlled variables (CVs). The modular control system further includes a main controller configured to execute a control process to generate targets for the plurality of subsystem predictive controllers. The control process includes adjusting a plurality of manipulated variables (MVs) including targets for the plurality of CVs and providing the plurality of MVs as inputs to the plurality of subsystem predictive controllers during a first time period. The main controller is configured to detect an event that causes one or more CVs of the plurality of CVs to become at least partially uncontrollable. In response to detecting the event, the main controller is configured to modify the control process to compensate for the event. The main controller is configured to execute the modified control process which includes adjusting a subset of MVs of the plurality of MVs and providing the subset of MVs as inputs to the plurality of subsystem predictive controllers during a second time period. The plurality of subsystem predictive controllers are configured to operate the plurality of interconnected subsystems to affect at least a subset of CVs of the plurality of CVs during the second time period based on targets for the subset of CVs provided by the subset of MVs.

In some embodiments, the main controller includes a deep learning predictor configured to generate values of the plurality of CVs predicted to result from the adjusted values of the plurality of MVs using a predictor neural network. In some embodiments, the main controller includes a deep learning controller configured to generate adjusted values of the plurality of MVs as outputs of a controller neural network and a deep learning predictor configured to predict values of the plurality of CVs predicted to result from the adjusted values of the plurality of MVs as outputs of a predictor neural network.

In some embodiments, modifying the control process includes modifying one or more predictor models of the main controller to change from (i) predicting values for all of the plurality of CVs during the first time period to (ii) predicting values for only the subset of CVs during the second time period. In some embodiments, modifying the control process includes modifying one or more predictive controllers of the main controller to change from (i) generating values for all of the plurality of MVs during the first time period to (ii) generating values for only the subset of MVs during the second time period.

In some embodiments, the event that causes the one or more CVs to become at least partially uncontrollable is a shutdown of one or more subsystems of the plurality of interconnected subsystems that operate to affect the one or more CVs. Modifying the control process may include causing the main controller to change from (i) using a first model trained with historical values of the plurality of CVs and the plurality of MVs associated with all of the plurality of interconnected subsystems to (ii) using a second model trained with historical values of the subset of CVs and the subset of MVs associated with a subset of the plurality of interconnected subsystems excluding the one or more subsystems for which the shutdown is detected.

In some embodiments, each of the plurality of subsystem predictive controllers corresponds to one of the plurality of interconnected subsystems and includes a deep learning predictor configured to predict values of one or more of the plurality of CVs associated with the corresponding subsystem using a predictor neural network based on the control signals generated by the deep learning controller. In some embodiments, each of the plurality of subsystem predictive controllers corresponds to one of the plurality of interconnected subsystems and includes (i) a deep learning controller configured to generate control signals for equipment of the corresponding subsystem as outputs of a controller neural network based on the targets provided by the main controller and (ii) a deep learning predictor configured to predict values of one or more of the plurality of CVs associated with the corresponding subsystem as outputs of a predictor neural network based on the control signals generated by the deep learning controller.

In some embodiments, the main controller includes an optimization-based controller configured to generate adjusted values of the plurality of MVs by performing an optimization of a reward function based on predicted values of the plurality of CVs. The main controller may include a predictor model configured to generate the predicted values of the plurality of CVs predicted to result from the adjusted values of the plurality of MVs.

In some embodiments, each of the plurality of subsystem predictive controllers corresponds to one of the plurality of interconnected subsystems and includes (i) an optimization-based controller configured to generate adjusted values of a plurality of MVs of the corresponding subsystem by performing an optimization of a reward function based on predicted values of the plurality of CVs and (ii) a predictor model configured to generate the predicted values of the plurality of CVs predicted to result from the adjusted values of the plurality of MVs of the corresponding subsystem.

In some embodiments, modifying the control process includes modifying an optimization process performed by the main controller to generate adjusted values of the plurality of MVs. Modifying the optimization process may include removing the one or more CVs which have become at least partially uncontrollable from at least one of (i) a reward function evaluated by the main controller when performing the optimization process, (ii) one or more models used by the main controller when performing the optimization process, or (iii) one or more constraints on the optimization process evaluated by the main controller when performing the optimization process.

In some embodiments, the plurality of MVs include one or more flex MVs that transition between being controllable by the main controller and uncontrollable by the main controller. The event that causes the one or more CVs to become at least partially uncontrollable may be a transition into a control scenario in which the one or more flex MVs are uncontrollable by the main controller. Modifying the control process may include causing the main controller to stop using the one or more flex MVs to control the one or more CVs in response to detecting that the one or more flex MVs have become uncontrollable by the main controller.

In some embodiments, the plurality of MVs include one or more flex MVs that transition between being controllable by the main controller and uncontrollable by the main controller. The main controller may include a plurality of predictive controllers trained to handle a plurality of different control scenarios in which different subsets of the flex MVs are controllable and uncontrollable. Modifying the control process may include causing the main controller to change from (i) using a first predictive controller trained to handle a first control scenario in which a first subset of the flex MVs are controllable to (ii) using a second predictive controller trained to handle a second control scenario in which a second subset of the flex MVs are controllable.

In some embodiments, detecting the event that causes the one or more CVs to become at least partially uncontrollable includes detecting a failure of the one or more CVs to reach one or more targets for the CVs provided by the main controller. The failure may prevent the one or more CVs from being increased above a maximum CV wind-up limit or decreased below a minimum CV wind-up limit. The main controller may be configured to translate the failure of the one or more CVs to reach the one or more targets into wind-up in one or more corresponding MVs of the main controller that include the one or more targets for the one or more CVs of the plurality of interconnected subsystems. Modifying the control process may include preventing the one or more corresponding MVs of the main controller from being increased above a maximum MV wind-up limit or decreased below a minimum MV wind-up limit.

Another implementation of the present disclosure is a method for operating a modular control system for a plant having a plurality of interconnected subsystems. The method includes executing a control process at a main controller during a first time period. The control process includes adjusting a plurality of manipulated variables (MVs) including targets for a plurality of controlled variables (CVs). The method includes using a plurality of subsystem predictive controllers to operate the plurality of interconnected subsystems to affect the plurality of CVs during the first time period based on the targets for the plurality of CVs provided by the main controller. The method includes, in response to detecting an event that causes one or more CVs of the plurality of CVs to become at least partially uncontrollable, modifying the control process to compensate for the event. The method includes executing the modified control process at the main controller during a second time period. The modified control process includes adjusting a subset of MVs of the plurality of MVs including targets for a subset of CVs of the plurality of CVs. The method includes using the plurality of subsystem predictive controllers to operate the plurality of interconnected subsystems to affect at least the subset of CVs during the second time period based on the targets for the subset of CVs provided by the main controller.

In some embodiments, executing the control process or the modified control process at the main controller includes using a deep learning predictor of the main controller to generate values of the plurality of CVs predicted to result from the adjusted values of the plurality of MVs using a predictor neural network. In some embodiments, executing the control process or the modified control process at the main controller includes using a deep learning controller of the main controller to generate adjusted values of the plurality of MVs as outputs of a controller neural network and using a deep learning predictor of the main controller to predict values of the plurality of CVs predicted to result from the adjusted values of the plurality of MVs as outputs of a predictor neural network.

In some embodiments, modifying the control process includes modifying one or more predictor models of the main controller to change from (i) predicting values for all of the plurality of CVs during the first time period to (ii) predicting values for only the subset of CVs during the second time period. In some embodiments, modifying the control process includes modifying one or more predictive controllers of the main controller to change from (i) generating values for all of the plurality of MVs during the first time period to (ii) generating values for only the subset of MVs during the second time period.

In some embodiments, the event that causes the one or more CVs to become at least partially uncontrollable is a shutdown of one or more subsystems of the plurality of interconnected subsystems that operate to affect the one or more CVs. Modifying the control process may include causing the main controller to change from (i) using a first model trained with historical values of the plurality of CVs and the plurality of MVs associated with all of the plurality of interconnected subsystems to (ii) using a second model trained with historical values of the subset of CVs and the subset of MVs associated with a subset of the plurality of interconnected subsystems excluding the one or more subsystems for which the shutdown is detected.

In some embodiments, using the plurality of subsystem predictive controllers to operate the plurality of interconnected subsystems includes using a deep learning predictor of the plurality of subsystem predictive controllers to predict values of one or more of the plurality of CVs using a predictor neural network based on the control signals generated by the deep learning controller. In some embodiments, using the plurality of subsystem predictive controllers to operate the plurality of interconnected subsystems includes using a deep learning controller of the plurality of subsystem predictive controllers to generate control signals for equipment of the plurality of interconnected subsystems as outputs of a controller neural network based on the targets provided by the main controller and using a deep learning predictor of the plurality of subsystem predictive controllers to predict values of one or more of the plurality of CVs as outputs of a predictor neural network based on the control signals generated by the deep learning controller.

In some embodiments, executing the control process or the modified control process at the main controller includes using an optimization-based controller of the main controller to generate adjusted values of the plurality of MVs by performing an optimization of a reward function based on predicted values of the plurality of CVs and using a predictor model of the main controller to generate the predicted values of the plurality of CVs predicted to result from the adjusted values of the plurality of MVs.

In some embodiments, using the plurality of subsystem predictive controllers to operate the plurality of interconnected subsystems includes (i) using an optimization-based controller of the plurality of subsystem predictive controllers to generate adjusted values of a plurality of MVs of a corresponding subsystem by performing an optimization of a reward function based on predicted values of the plurality of CVs and (ii) using a predictor model of the plurality of subsystem predictive controllers to generate the predicted values of the plurality of CVs predicted to result from the adjusted values of the plurality of MVs of the corresponding subsystem.

In some embodiments, modifying the control process includes modifying an optimization process performed by the main controller to generate adjusted values of the plurality of MVs. Modifying the optimization process may include removing the one or more CVs which have become at least partially uncontrollable from at least one of (i) a reward function evaluated by the main controller when performing the optimization process, (ii) one or more models used by the main controller when performing the optimization process, or (iii) one or more constraints on the optimization process evaluated by the main controller when performing the optimization process.

In some embodiments, the plurality of MVs include one or more flex MVs that transition between being controllable by the main controller and uncontrollable by the main controller. The event that causes the one or more CVs to become at least partially uncontrollable may be a transition into a control scenario in which the one or more flex MVs are uncontrollable by the main controller. Modifying the control process may include causing the main controller to stop using the one or more flex MVs to control the one or more CVs in response to detecting that the one or more flex MVs have become uncontrollable by the main controller.

In some embodiments, the plurality of MVs include one or more flex MVs that transition between being controllable by the main controller and uncontrollable by the main controller. The method may include training a plurality of predictive controllers of the main controller to handle a plurality of different control scenarios in which different subsets of the flex MVs are controllable and uncontrollable. Modifying the control process may include causing the main controller to change from (i) using a first predictive controller trained to handle a first control scenario in which a first subset of the flex MVs are controllable to (ii) using a second predictive controller trained to handle a second control scenario in which a second subset of the flex MVs are controllable.

In some embodiments, detecting the event that causes the one or more CVs to become at least partially uncontrollable includes detecting a failure of the one or more CVs to reach one or more targets for the CV provided by the main controller. The failure may prevent the one or more CVs from being increased above a maximum CV limit or decreased below a minimum CV limit. The method may include translating the failure of the one or more CVs to reach the one or more targets into wind-up in one or more corresponding MVs of the main controller that include the one or more targets for the one or more CVs of the plurality of interconnected subsystems. Modifying the control process may include preventing the one or more corresponding MVs of the main controller from being increased above a maximum MV wind-up limit or decreased below a minimum MV wind-up limit.

Another implementation of the present disclosure is a predictive controller for a plant. The predictive controller includes one or more processors and one or more non-transitory computer-readable media storing instructions that, when executed by the one or more processors, cause the one or more processors to perform operations. The operations include executing a predictive control process that includes adjusting a plurality of manipulated variables (MVs) including targets for equipment of the plant and providing the plurality of MVs as inputs to the equipment of the plant during a first time period. The operations further include, in response to detecting an event that causes one or more MVs of the plurality of MVs to become at least partially uncontrollable, modifying the predictive control process to compensate for the event. The operations further include executing the modified predictive control process comprising adjusting a subset of MVs of the plurality of MVs and providing the subset of MVs as inputs to the equipment of the plant during a second time period. The equipment of the plant operate to affect a plurality of controlled variables (CVs) of the plant during the second time period based on the targets provided by the plurality of MVs.

In some embodiments, the plurality of MVs include one or more flex MVs that transition between being controllable and uncontrollable, the event that causes the one or more MVs to become at least partially uncontrollable is a transition into a control scenario in which the one or more flex MVs are uncontrollable, and modifying the predictive control process includes causing the predictive controller to stop using the one or more flex MVs to control the plurality of CVs in response to detecting that the one or more flex MVs have become uncontrollable.

In some embodiments, the plurality of MVs include one or more flex MVs that transition between being controllable and uncontrollable, the predictive controller includes a plurality of predictive controllers or a plurality of operating modes trained to handle a plurality of different control scenarios in which different subsets of the flex MVs are controllable and uncontrollable, and modifying the predictive control process includes causing the predictive controller to change from (i) using a first predictive controller or first operating mode trained to handle a first control scenario in which a first subset of the flex MVs are controllable to (ii) using a second predictive controller or second operating mode trained to handle a second control scenario in which a second subset of the flex MVs are controllable.

In some embodiments, the event that causes the one or more MVs to become at least partially uncontrollable includes wind-up in the one or more MVs and modifying the predictive control process includes preventing the one or more MVs from being increased above a maximum MV wind-up limit or decreased below a minimum MV wind-up limit.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of an exemplary oil refinery system in which the modular control systems and methods described herein can be implemented, according to an exemplary embodiment.

FIG. 2 is a block diagram of a control system including a plant controller and a plant, according to an exemplary embodiment.

FIG. 3 is a block diagram illustrating a training process for the predictor model of the plant controller in FIG. 2, according to an exemplary embodiment.

FIG. 4 is a block diagram illustrating a training process for the predictive controller of the plant controller in FIG. 2, according to an exemplary embodiment.

FIG. 5 is a block diagram illustrating a portion of the control system of FIG. 2 in greater detail including a main controller and several subsystem controllers, according to an exemplary embodiment.

FIG. 6 is a block diagram illustrating a portion of the control system of FIG. 2 in greater detail in which the main controller and the subsystem controllers are arranged as hierarchical deep learning process controllers, according to an exemplary embodiment.

FIG. 7 illustrates several graphs of manipulated variables (MVs) and controlled variables (CVs) which can be adjusted and controlled by the main controller and subsystem controllers, according to an exemplary embodiment.

FIG. 8 is a block diagram illustrating the operation of the main controller and subsystem controllers to predict a partial system state and adjust a subset of MVs when one or more of the subsystems are offline, according to an exemplary embodiment.

FIG. 9 is a flowchart of a process which can be performed by the main controller of FIG. 8 to generate a partial set of MVs when one or more subsystems are offline, according to an exemplary embodiment.

FIG. 10 is a block diagram illustrating a portion of the control system of FIG. 2 in greater detail in which the main controller and the subsystem controllers operate as a mesh optimizer, according to an exemplary embodiment.

FIG. 11 is a block diagram illustrating the operation of the main controller and subsystem controllers in the mesh optimizer embodiment when the state of an offline subsystem is used to calculate a common variable, according to an exemplary embodiment.

FIG. 12 is a flowchart of a process which can be performed by the main controller of FIG. 11 to adapt an optimization process to compensate for an offline subsystem, according to an exemplary embodiment.

FIG. 13 is a block diagram of a controller which can be used as the main controller or subsystem controllers described herein, or as a separate non-modular controller, and configured to change control strategies based on flex MVs, according to an exemplary embodiment.

FIG. 14 is a flowchart of a process which can be performed by the controller of FIG. 13 to change control strategies based on flex MVs, according to an exemplary embodiment.

FIG. 15A is a block diagram illustrating a portion of the control system of FIG. 2 in greater detail in which the main controller and the subsystem controllers compensate for wind-up in one or more variables, according to an exemplary embodiment.

FIG. 15B is a block diagram illustrating a control system which can be implemented as a portion of the modular control system described herein or as a separate non-modular control system and configured to compensate for wind-up in one or more variables, according to an exemplary embodiment.

FIG. 16 illustrates several graphs of manipulated variables and controlled variables which can be adjusted and controlled by the main controller and subsystem controllers when wind-up is present in one or more variables, according to an exemplary embodiment.

FIG. 17 is a flowchart of a process which can be performed by the subsystem controllers and main controller to compensate for wind-up in one or more CVs or MVs, according to an exemplary embodiment.

FIG. 18 is a flowchart of a process which can be performed by the control system of FIG. 2 to modify the control process in response to detecting an event that causes one or more of the CVs to become at least partially uncontrollable, according to an exemplary embodiment.

### DETAILED DESCRIPTION

### Overview

Referring generally to the FIGURES, predictive control systems and methods for monitoring and controlling modular systems are shown, according to exemplary embodiments. A modular system or plant includes multiple interconnected subunits or subsystems with specific control needs. The subsystems may be connected to each other in various parallel and/or series arrangements. For example, the outputs of one or more upstream subsystems may feed into one or more downstream subsystems in series, or two or more parallel subsystems may operate in parallel with each other. Each subsystem may be controlled by a corresponding subsystem controller which operates controllable equipment of its respective subsystem to control the various functions thereof. A main controller may oversee the subsystem controllers and provide targets for each subsystem controller to achieve by operating its respective subsystem.

As described herein, a predictive control system uses advanced neural network models to predict, control, and optimize the performance of various subsystems within a modular system or plant. In some embodiments, deep learning process control (DLPC) is used to enhance efficiency, reduce operational costs, and maximize output by analyzing and learning over extensive process data, identifying patterns, and making precise adjustments. Implementing such neural network models in real-world plants involves addressing challenges across multiple interconnected subsystems. Because changes in one subsystem can affect other subsystems, a comprehensive solution must consider the dependencies and interactions between subsystems to ensure effective coordination and optimization throughout the plant.

The present disclosure addresses these challenges using predictive control methods specifically tailored for modular systems, each designed to handle different operational challenges. One approach described herein is designed to overcome issues such as model complexity and subsystem shutdowns, utilizing a DLPC structure with adaptations. Another approach described herein uses an optimization-based control (e.g., model predictive control) which provides benefits when the variability of the control scenarios is high. Additionally, two general process control techniques (i.e., flex MVs and wind-up) which are used in regular systems to address common control challenges are modified for modular systems. These methods enhance adaptability to scenarios involving uncontrollable handles and action constraints, ensuring robust and reliable system control. These and other features are described in greater detail below.

### Oil Refinery System

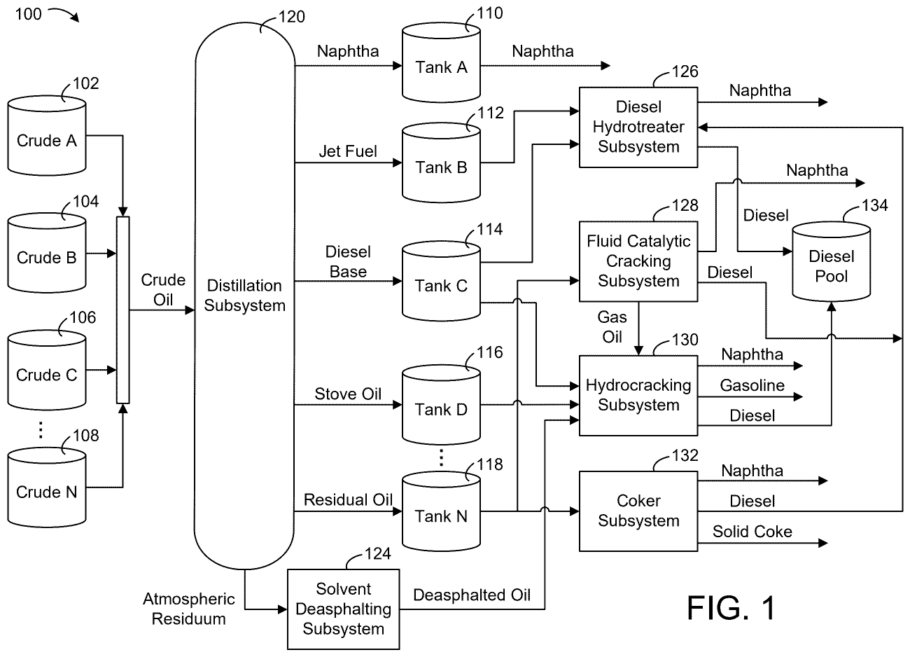

Referring now to FIG. 1, a block diagram of an oil refinery system 100 is shown, according to an exemplary embodiment. Oil refinery system 100 is one example of a controllable system or plant in which the predictive systems and methods of the present disclosure can be implemented. However, it should be understood that the systems and methods described herein are not limited to oil refinery system 100 and can be used to monitor and/or control any of a wide variety of controllable systems or processes (e.g., mechanical processes, chemical processes, electrical processes, manufacturing processes, etc.) across a variety of different industries or applications. For ease of explanation, the following disclosure describes an exemplary embodiment of the predictive control systems and methods applied to oil refinery system 100, with the understanding that oil refinery system 100 can be replaced or supplemented with any other type of controllable system or process in various other implementations.

Oil refinery system 100 may operate to transform crude oil or other crude petroleum products into more useful products such as gasoline, petrol, kerosene, jet fuel, diesel, etc. System 100 is shown to include several subsystems which operate as interconnected units or subprocesses. For example, system 100 is shown to include several crude sources (i.e., crude A 102, crude B 104, crude C 106, and crude N 108), a distillation subsystem 120, several tanks (i.e., tank A 110, tank B 112, tank C 114, tank D 116, and tank N 118), a solvent deasphalting subsystem 124, a diesel hydrotreater subsystem 126, a fluid catalytic cracking subsystem 128, a hydrocracking subsystem 130, and a coker subsystem 132. Although only four crude oil sources 102-108 are shown in FIG. 1, it is contemplated that system 100 can receive crude oil from any number of sources. Additionally, although only five tanks 110-118 are shown in FIG. 1, it is contemplated that system 100 can include any number of tanks to store derived petroleum products produced and/or used by the various subsystems 120-132.

Crude oil or other crude petroleum products received from crude sources 102-108 can be provided as inputs to distillation subsystem 120. For ease of explanation, the term crude oil is used throughout the present disclosure to refer to any type of crude petroleum product provided as an input to oil refinery system 100. Distillation subsystem 120 can include one or more atmospheric distillation units (ADUs), vacuum distillation units (VDUs), any other type of crude distillation towers, or any other type of distillation unit which operates to separate the crude oil into various derived petroleum products. Such derived petroleum products are shown in FIG. 1 as including naphtha, jet fuel, diesel base, stove oil, residual oil, and atmospheric residuum, but can include any type of derived petroleum product in various implementations.

Each derived petroleum product can be stored in a respective tank of tanks 110-118, provided as inputs to other subsystems 124-132 of oil refinery system 100, and/or provided as an output product of system 100. For example, solvent deasphalting subsystem 124 is shown receiving the atmospheric residuum generated by distillation subsystem 120 and may operate to convert the atmospheric residuum into deasphalted oil. Similarly, diesel hydrotreater subsystem 126, fluid catalytic cracking subsystem 128, hydrocracking subsystem 130, and coker subsystem 132 may receive various combinations of the derived petroleum products generated by distillation subsystem 120 and solvent deasphalting subsystem 124 and may further process or convert such inputs into naphtha, gasoline, diesel (e.g., ultra-low sulfur diesel), solid coke, or other output products. Such output products can be stored within oil refinery system 100 and/or provided as an output product of system 100.

Several examples of oil refinery systems and processes which can be used as subsystems 120-132 are described in detail in U.S. patent application Ser. No. 16/888,128 filed May 29, 2020, U.S. patent application Ser. No. 16/950,643 filed Nov. 17, 2020, U.S. patent application Ser. No. 17/308,474 filed May 5, 2021, U.S. patent application Ser. No. 17/384,660 filed Jul. 23, 2021, U.S. patent application Ser. No. 17/831,227 filed Jun. 2, 2022, and U.S. patent application Ser. No. 18/403,179 filed Jan. 3, 2024, all of which are incorporated by reference herein in their entireties. It is contemplated that oil refinery system 100 can include some or all of the components, systems, and/or functionality described in the aforementioned patent applications.

Diesel pool 134 represents the combined output of several subsystems of oil refinery system 100 that produce diesel-qualifying barrels (e.g., diesel hydrotreater subsystem 126 and hydrocracking subsystem 130). In some embodiments, multiple streams from subsystems 126 and 130 are blended to create the final diesel product to meet specific product specifications. Key product specifications of diesel pool 134 include cloud point, pour point, 90% boiling point (T90), final boiling point (FBP), and sulfur content. These and other product specifications of diesel pool 134 can be controlled by adjusting the operation of subsystems 120-132 using a modular control scheme. For example, each of subsystems 120-132 can be controlled using subsystem controller or child controller for that subsystem specifically. The various subsystem controllers can be supervised or controlled by a main controller or parent controller which provides targets or setpoints to each subsystem controller. The architecture and operation of the modular control system is described in greater detail below.

Control System with Plant Controller and Predictor Model

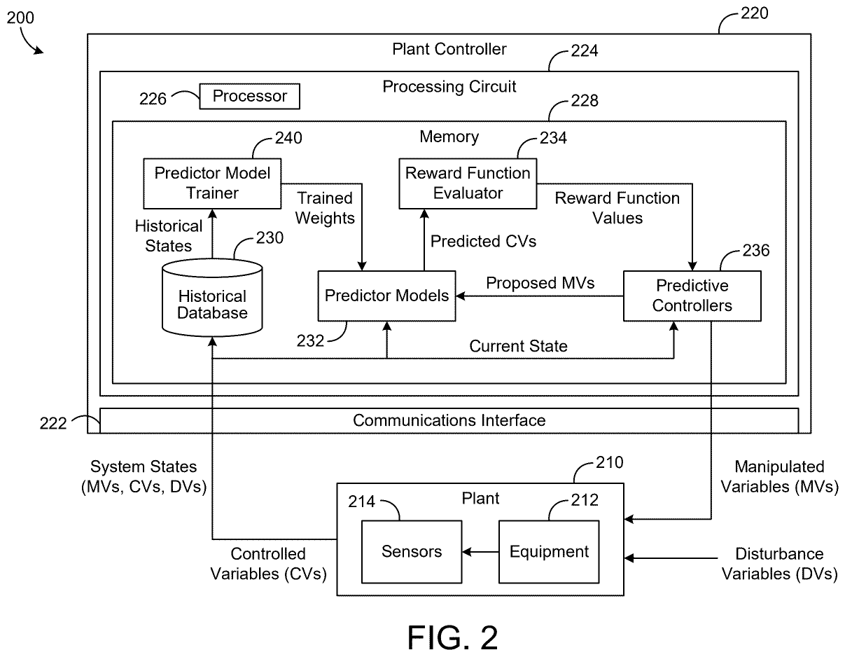

Referring now to FIG. 2, a block diagram of a control system 200 is shown, according to an exemplary embodiment. Control system 200 is shown to include a plant 210 and a plant controller 220. A plant in control theory is the combination of a process and controllable equipment capable of affecting the process. Plant 210 can include any type of controllable system or process. In some embodiments, plant 210 includes an oil refinery system such as oil refinery system 100 as described with reference to FIG. 1. However, it is contemplated that plant 210 is not limited to oil refinery system 100 and can include any of a wide variety of controllable systems or processes (e.g., mechanical processes, chemical processes, electrical processes, manufacturing processes, etc.) across a variety of different industries or applications. Plant 210 may include multiple interconnected subsystems (e.g., subsystems 120-132) which operate in coordination with one another, for example as described with reference to FIG. 1.

Plant 210 is shown to include equipment 212 and sensors 214. Equipment 212 can include any type of controllable equipment capable of affecting the process represented by plant 210. Examples of equipment 212 include valves, actuators, pumps, fans, burners, chillers, robotic assemblies, mixers, or any other type of equipment. The particular type or types of equipment 212 included in plant 210 depends on the type of controllable system or process and may include any type of equipment 212 suitable for use in that system or process. For example, in a system such as oil refinery system 100, equipment 212 may include oil tanks, atmospheric distillation units (ADUs), vacuum distillation units (VDUs), coker subsystems, fluid catalytic cracker units (FCCUs), hydrocracking units (HUs), or any other type of equipment suitable for oil refinery operations. Sensors 214 can include any of a wide variety of sensors (e.g., meters, measurement devices, sensing devices, etc.) capable of monitoring the controllable system or process represented by plant 210. For example, sensors 214 can include temperature sensors, pressure sensors, weight sensors, chemical sensors, motion sensors, proximity sensors, magnetic sensors, ultrasonic transducers, capacitive sensors, light sensors, or any other type of sensor capable of measuring a variable state or condition of plant 210.

The state of plant 210 at a given time or over a given time period (e.g., a time window) can be represented by a set of manipulated variables (MVs), controlled variables (CVs), and disturbance variables (DVs). MVs may include any variables that can be manipulated or adjusted by plant controller 220, for example to cause a desired change in the operation of plant 210. MVs may include control signals that are provided as inputs to equipment 212, setpoints that are provided as inputs to lower level controllers for equipment 212, or other variables that can be directly manipulated (e.g., adjusted, set, modulated, etc.) by plant controller 220. Examples of MVs in oil refinery system 100 can include the temperatures or pressures within an atmospheric distillation unit, vacuum distillation unit, fractionator, coke drums, and/or furnace, the positions of various valves, the feed rates of crude oil, residual oil, and/or coking vapor into various equipment 212, or any other controllable variable parameter that can be adjusted to control the operation of plant 210, or any combination thereof. MVs may have a direct or indirect effect on the values of the CVs which are affected by operating equipment 212 of plant 210.

In some embodiments, MVs include variables that are provided as inputs to plant 210 and affect the values of the CVs, but are not necessarily controlled or adjusted by plant controller 220. For example, some MVs may have values set by another system or device outside the control of plant controller 220 (e.g., a supervisory controller, a remote system or device, a user device, etc.).

CVs may include one or more variables that can be controlled by operating equipment 212 of plant 210. In some embodiments, the CVs represent the outputs of plant 210 and are affected by the process represented by plant 210. The CVs may quantify the performance of plant 210 and/or quality of one or more variables affected by plant 210. Examples of CVs may include measured values (e.g., temperature, pressure, energy consumption, etc.), calculated values (e.g., efficiency, coefficient of performance (COP), etc.), yield of one or more oil products produced by plant 210, error of a measured or calculated variable relative to a setpoint or target value, or any other values that characterize the performance or state of a controllable system or process. Some CVs may represent quantities that are not capable of being directly manipulated by plant controller 220 (and thus do not qualify as MVs), but rather can be affected by manipulating the corresponding MVs that affect the CVs by operation of plant 210. CVs may include the volumes, flow rates, mass, or other variables that quantify the amount of the various output products produced by plant 210 and/or any metrics based on such variables (e.g., error relative to a setpoint or target).

DVs may represent disturbances that can cause CVs to deviate from their respective set points or otherwise affect the operation of plant 210. Examples of DVs include measurable or unmeasurable disturbances to system 100 such as outside air temperature, outside air humidity, uncontrolled sources of heat transfer, etc. DVs are typically not controllable, but may be measurable or unmeasurable depending on the type of disturbance. Any of the variables described as MVs may be DVs in some embodiments in which plant controller 220 cannot control those variables. Similarly, any of the variables described as DVs may be MVs in some embodiments in which plant controller 220 can control those variables. Examples of DVs in the exemplary oil refinery system 100 can include input oil feed composition, hydrogen flow rate, reactor pressure, catalyst age, separation and/or fractionation section temperatures and pressures, reactor temperature differentials, intermediate flow rates, upstream unit process operating conditions, or any combination thereof, to the extent that such variables are not directly controllable by plant controller 220.

In some embodiments, one or more of the CVs, DVs, or MVs are not provided by actual sensors, but rather are virtual variables which are calculated from one or more other CVs, DVS, or MVs and/or from one or more other sensor readings. In various embodiments, the virtual variables can be defined as linear or non-linear functions of one or more other variables or sensor readings.

The CVs may include one or more virtual controlled variables that represent a signal sampled at a low rate, for example, lower than once every 10, 50, 100 or 1,000 time points in which regular CVs are measured. In some embodiments, the values at the intermediate time points are estimated by interpolation from the values at the measured time points. Alternatively or additionally, machine learning is applied to the values of the CVs and possibly the MVs and/or DVs at the time points at which the low-rate sampled variables were sampled, to determine a connection between the other controlled, disturbance and/or manipulated variables and the low-rate sampled variables. A resultant function can then be applied to the values of the CVs, DVs, and/or MVs at the time points for which the low-rate sampled variable was not measured to provide inferred values for these times of the low-rate sampled variables. Alternatively to the low-rate sampled variables being calculated as a function of the other variables at a single time point, the values of the low-rate sampled variables can be calculated based on values of the other variables in a plurality of time points in the vicinity of the time point for which the values of the low-rate sampled variables are calculated. For example, a machine learning device can be trained to predict low-rate sampled variable values at each given time point, based on 10-20 time points before and/or after the given time point. In some embodiments, the values of the low-rate sampled variables are inferred via a combination of interpolation from the sampled values and the resultant function from the machine learning.

The time points for which values are stored in historical database 230 may include time points separated by regular periods, such as every 5 seconds, 15 seconds, half minute, minute, five minutes or fifteen minutes. The time points for which values are stored in historical database 230 may span over a relatively long period, for example, at least a week, at least a month, at least a year or even at least 3 years or more. In some embodiments, values are collected for at least 1,000 time points, for at least 10,000 time points, for at least 100,000 time points or even for at least a million time points. It is noted that if values are collected every fifteen seconds, values for 5,760 time points are collected every day, such that in some embodiments, more than 2 million time points per year are collected and considered by plant controller 220. In some embodiments, values for time points of at least 1 year, at least 3 years or even at least 5 years are used by plant controller 220 in generating predictor models 232 and/or predictive controllers 236.

The number of variables having values at each time point may be relatively small, for example less than 10 variables or even less than five variables, or may be very large, for example more than 50 variables, more than 100 variables, more than 1,000 variables or even more than 10,000 variables. Additional details regarding the number and types of variables which can be used in system 200 are described in detail in U.S. patent application Ser. No. 18/081,721 filed Dec. 15, 2022, the entire disclosure of which is incorporated by reference herein.

In operation, the MVs can be generated by plant controller 220 and provided as inputs to plant 210. Plant controller 220 may generate and provide setpoints that indicate values to which the MVs will be directed. In some embodiments, the setpoints generated by plant controller 220 indicate the values of the MVs directly by providing the desired values of the corresponding variables represented by the MVs. For example, if a given MV represents the feed rate of an input oil feed into a reactor, the value of the MV can be provided as a volume or mass flow rate of the input oil feed (e.g., kg/s, m³/s, etc.) representing the desired rate at which to feed the oil into the reactor. In other embodiments, the setpoints generated by plant controller 220 indicate the values of the MVs indirectly by providing “MV moves” which indicate changes in the MVs relative to their previous values. For example, if the previous mass flow rate of the input oil feed represented by an MV was 2 kg/s and the desired feed rate is 3 kg/s, plant controller 220 may provide an MV move of +1 kg/s for the corresponding MV to cause plant 210 to increase the mass flow rate from 2 kg/s to 3 kg/s. Plant 210 can process the MV moves by increasing or decreasing the values of the corresponding MVs by the values indicated by the MV moves. Values of the CVs and the DVs can similarly be represented as either the actual values of the corresponding variables or as “CV moves” or “DV moves” respectively. For example, plant 210 can provide the CVs and DVs to plant controller 220 as either the actual values of the CVs or the DVs at a given time or as CV moves or DV moves that indicate changes relative to the previous values of the CVs and DVs.

The values of the MVs affect operation of plant 210 and thus influence the values of the CVs provided as outputs of plant 210. Plant 210 and the values of the CVs can also be affected by the DVs, which are shown in FIG. 2 as additional (uncontrolled) inputs to plant 210 but not directly controlled by plant controller 220. The set of values of the MVs, CVs, and DVs at a given time or over a given time period (i.e., a window of time) and define the state of system 200 at that time/period, referred to herein as the “system state.” The system state can be observed and/or recorded at each time or each window of time and stored in a historical database 230. Although historical database 230 is shown as a component of plant controller 220, it is contemplated that historical database 230 can be separate from plant controller 220 in some embodiments. The real-time state of system 200 can also be provided as an input to plant controller 220 during online operation of plant 210 and used by various components of plant controller 220 as described herein to generate the values of the MVs.

Still referring to FIG. 2, plant controller 220 is shown to include a communications interface 222 and a processing circuit 224. Communications interface 222 can be or include wired or wireless communications interfaces (e.g., jacks, antennas, transmitters, receivers, transceivers, wire terminals, etc.) for conducting data communications. In various embodiments, communications via communications interface 222 can be direct (e.g., local wired or wireless communications) or via a communications network (e.g., a WAN, the Internet, a cellular network, etc.). For example, communications interface can include an Ethernet card and port for sending and receiving data via an Ethernet-based communications link or network. In another example, communications interface 222 can include a Wi-Fi transceiver for communicating via a wireless communications network. In another example, communications interface 222 can include cellular or mobile phone communications transceivers.

Processing circuit 224 is shown to include a processor 226 and memory 228. Processing circuit 224 can be communicably connected to communications interface 222 such that processing circuit 224 and the various components thereof can send and receive data via communications interface 222. Processor 226 can be implemented as a general-purpose processor, an application specific integrated circuit (ASIC), one or more field programmable gate arrays (FPGAs), a group of processing components, or other suitable electronic processing components. In some embodiments, processor 226 includes one or more processors which can be located within a single physical device or distributed across multiple physical devices or systems.

Memory 228 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present disclosure. Memory 228 can be or include volatile memory or non-volatile memory. Memory 228 can include database components, object code components, script components, or any other type of information structure for supporting the various activities and information structures described in the present disclosure. According to an example embodiment, memory 228 is communicably connected to processor 226 via processing circuit 224 and includes computer code for executing (e.g., by processing circuit 224 and/or processor 226) one or more processes described herein.

Although plant controller 220 and the various components thereof (i.e., communications interface 222, processing circuit 224, processor 226, and memory 228) are shown as components of a single device in FIG. 2 for ease of illustration, it is contemplated that plant controller 220 can include multiple separate systems or devices that can be distributed across multiple physical locations in some embodiments. For example, some portions of plant controller 220 can be implemented on-site (e.g., at the same location as plant 210) whereas other portions of plant controller 220 can be located within an off-site computing system such as a remote operations center or a cloud-based computing system. All such embodiments and distributed or centralized implementations should be considered within the scope of the present disclosure.

Still referring to FIG. 2, plant controller 220 is shown to include a historical database 230, predictor models 232, reward function evaluator 234, predictive controllers 236, and predictor model trainer 240. In some embodiments, these components are implemented as functional modules of memory 228 or as data storage modules of memory 228. The functional modules of memory 228 (e.g., predictor models 232, reward function evaluator 234, predictive controllers 236, and predictor model trainer 240) can be executed by processor 226 to cause processor 226 to perform the various functions described herein as functions of these components. The data storage modules of memory 228 (e.g., historical database 230) can be accessed by processor 226 to retrieve or obtain the data stored therein (e.g., system states).

Historical database 230 may store the historical and current values of the system states including values of the MVs, CVs, and DVs generated or observed during operation of plant controller 220 and plant 210. Historical database 230 may store a value for each of the MVs, CVs, and DVs, and/or other variables of interest (e.g., values of the reward function), values of variables measured by sensors 214, etc.) for each time step t or for each time period. The values stored in historical database 230 for past time steps form a set of historical data (i.e., historical states) which can be used to train predictor models 232. The values of the system states for current time steps can similarly be stored in historical database 230 and/or can be provided as direct inputs to predictor models 232 and/or predictive controllers 236 during online operation of system 200 to monitor and control plant 210.

Predictor models 232 may include a subsystem-specific predictor model for each subsystem of plant 210. For example, as applied to oil refinery system 100, predictor models 232 may include a subsystem-specific predictor model for each of subsystems 120-132. Each of predictor models 232 may be configured to predict the CVs of the corresponding subsystem based on the current system state and a set of proposed MVs for the corresponding subsystem. For example, the predictor model 232 for distillation subsystem 120 can be configured to predict the amount and/or attributes of the naphtha, jet fuel, diesel base, stove oil, or residual oil produced by distillation subsystem 120 (i.e., the CVs of distillation subsystem 120) based on the amount and/or attributes of the crude oil provided as an input to distillation subsystem 120 and/or other variables affecting the operation of distillation subsystem 120 (i.e., the CVs and/or MVs of distillation subsystem 120). Similarly, the predictor model 232 for diesel hydrotreater subsystem 126 can be configured to predict the amount and/or attributes of the naphtha or diesel produced by diesel hydrotreater subsystem 126 (i.e., the CVs of diesel hydrotreater subsystem 126) based on the amount and/or attributes of the jet fuel and/or diesel base provided as inputs to diesel hydrotreater subsystem 126 and/or other variables affecting the operation of diesel hydrotreater subsystem 126 (i.e., the CVs and/or MVs of diesel hydrotreater subsystem 126). The subsystem-specific instances of predictor models 232 are referred to as subsystem models or child models throughout the present disclosure.

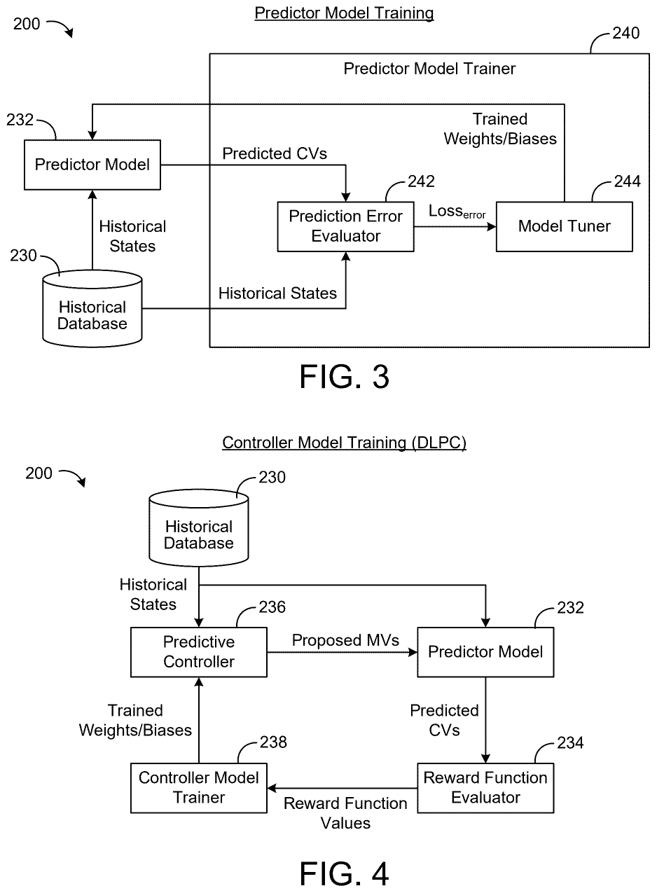

Predictor models 232 may also include a main predictor model for plant 210 as a whole. The main predictor model 232 can be configured to predict the CVs of plant 210 as a whole (e.g., the amounts and/or qualities of each petroleum product provided as an output of plant 210) based on a set of proposed MVs provided as inputs to each subsystem of plant 210 (e.g., target values to be achieved by each subsystem 120-132). In some embodiments, the main predictor model 232 is configured to predict the CVs of each subsystem 120-132 based on the MVs provided as inputs to each subsystem 120-132. The main predictor model 232 can be arranged hierarchically or cascaded with the subsystem-specific predictor models 232 such that the CVs in the subsystem-specific predictor models 232 are MVs in the main predictor model 232. Stated differently, the MVs in the main predictor model 232 may represent target values of the CVs to be achieved by the subsystems 120-132. For example, the main predictor model 232 can be configured to predict the amount or quality of the diesel generated by subsystems 126-130, which is a CV in the subsystem-specific predictor models 232 and adjusted as a MV in the main predictor model 232. The main predictor model 232 can treat each subsystem 126-130 as a lower level control loop (e.g., a PID) in the sense that each subsystem 126-130 seeks to achieve the value of the MV specified as a target in the higher level main control loop. Additional detail regarding the hierarchical or cascaded structure of the subsystem-specific predictor models 232 and main predictor model 232 is provided with reference to FIGS. 3-12.

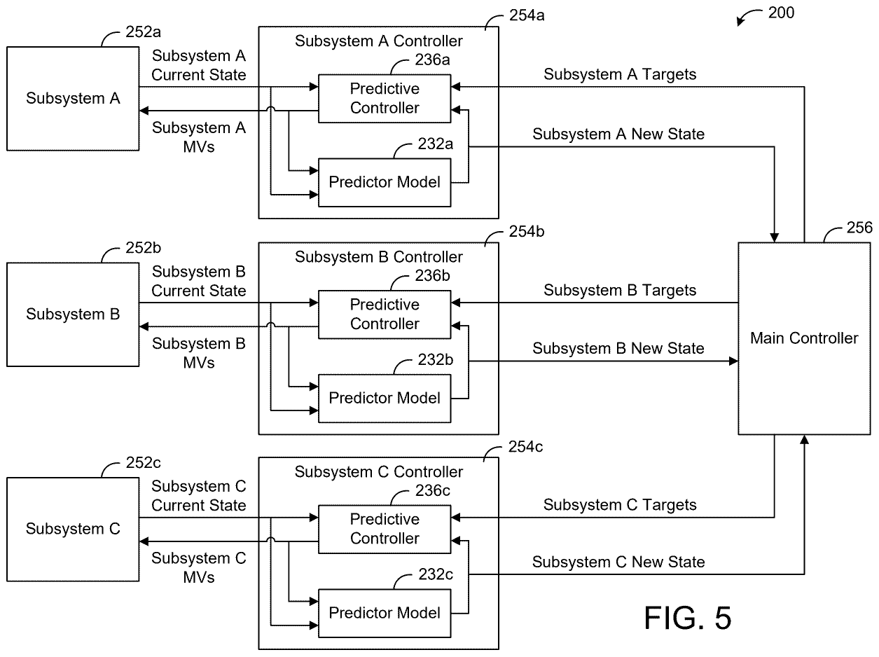

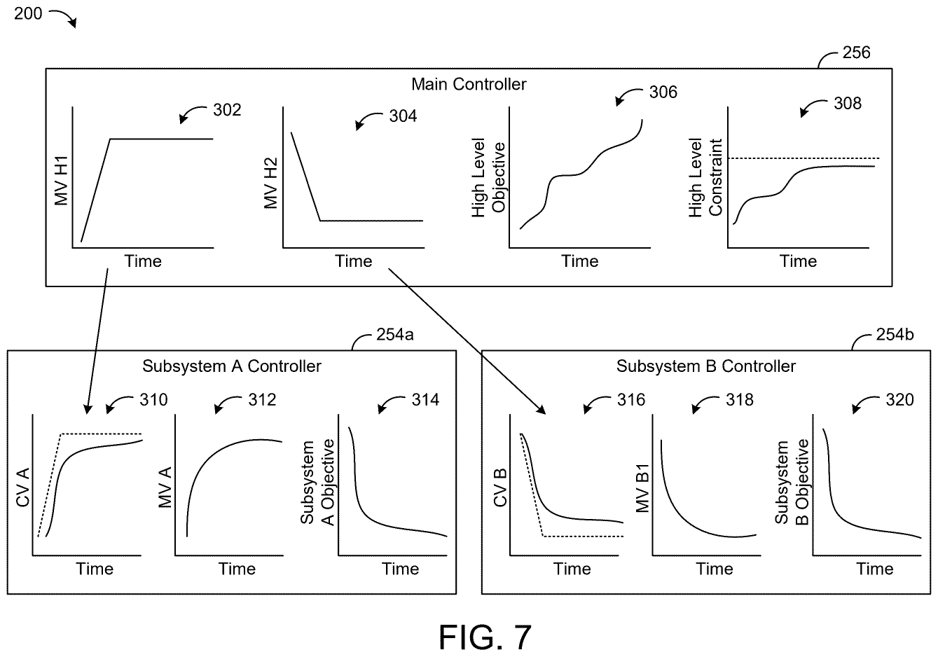

Predictor models 232 may include neural network models, parametric models, state-space models, or any other type of predictive model configured to predict the values of the CVs for the corresponding subsystem at the next time step based on the current system state and a set of proposed MVs for the corresponding subsystem. Various embodiments of these and other types of predictive models which can be used as predictor models 232 are described in detail in U.S. patent application Ser. No. 17/831,227 filed Jun. 2, 2022 (“the '227 application), the entire disclosure of which is incorporated by reference herein. For example, predictor models 232 may be the same as or similar to the predictive model shown in FIG. 5 of the '227 application or any of the predictor neural networks shown in FIG. 7, 9, 11, 13, or 17 of the '227 application. It is contemplated that the systems and methods described throughout the present application can be used in combination with any of the embodiments described in detail in the '227 application. During online operation of plant controller 220, predictor models 232 may receive the current system state as an input from historical database 230, plant 210, or other components of system 200 and may receive proposed MVs from predictive controllers 236. Predictor models 232 may output predicted values of the CVs which are predicted to result from the proposed MVs and the current system state.

Reward function evaluator 234 may receive the values of the CVs predicted by predictor models 232 and may use the predicted values of the CVs to evaluate the reward function J. The reward function/quantifies the performance of plant 210 or a subsystem thereof as a function of the CVs (and in some cases other variables in addition to the CVs) and may define one or more objectives which predictive controllers 236 seek to minimize or maximize. Reward function evaluator 234 can use the values of the CVs at one or more time steps to evaluate the reward function J. In some embodiments, the value of the reward function J at a given time t is based on the values of the CVs at that same time t (e.g., Jₜ=ƒ(c_{1,t}>c_{2,t}> . . . , c_{n,t})), where n is the total number of CVs included in the reward function J and the variables c_{1,t}, c_{2,t}> . . . , C_{n,t} are the values of the CVs at time t. In other embodiments, the value of the reward function/may be based on the values of the CVs over a predetermined time period including multiple time steps t

$$( e . g . , J = {\sum }_{{t}^{′} = t}^{t + k} f ( {c}_{1 , t}^{′} , {c}_{2 , t}^{′} , … , {c}_{n , t}^{′} ) ) ,$$

where k is the total number of time steps t included in the time period over which the reward function/is evaluated. In some embodiments, the values of one or more of the MVs and/or DVs at one or more time steps can be included in the reward function/in addition to the values of the CVs. Reward function evaluator 234 may obtain values of the CVs, MVs, and/or DVs for each time step in the reward function J and use the values of the CVs, MVs, and/or DVs to calculate the value of the reward function J.

Predictive controllers 236 may include a subsystem-specific controller for each subsystem of plant 210. For example, as applied to oil refinery system 100, predictive controllers 236 may include a subsystem-specific controller for each of subsystems 120-132. Each of predictive controllers 236 may receive the system states as feedback from plant 210 and may generate the MVs provided as input to a corresponding subsystem of plant 210. For example, the predictive controller 236 for distillation subsystem 120 can be configured to generate the MVs provided as inputs to distillation subsystem 120, whereas the predictive controller 236 for diesel hydrotreater subsystem 126 can be configured generate the MVs provided as inputs to diesel hydrotreater subsystem 126. The subsystem-specific instances of predictive controllers 236 are referred to as subsystem controllers or child controllers throughout the present disclosure. Each subsystem controller of predictive controllers 236 may be paired with a corresponding subsystem model of predictor models 232 to form a controller-model pair for the corresponding subsystem of plant 210.

Predictive controllers 236 may also include a main predictive controller 236 for plant 210 as a whole. The main predictive controller 236 can be configured to control and/or coordinate the operations of the various subsystems 120-132 by providing targets or setpoints for each subsystem 120-132 to achieve. In some embodiments, the MVs generated by the main predictive controller 236 may include setpoints or targets (e.g., constraints, optimization goals, etc.) for each of the subsystem-specific predictive controllers 236 to achieve by operating its corresponding subsystem 120-132. The main predictive controller 236 can be arranged hierarchically or cascaded with the subsystem-specific predictive controllers 236 such that the CVs of the subsystem-specific predictive controllers 236 are MVs of the main predictive controller 236. For example, the main predictive controller 236 may adjust target values (e.g., amounts or qualities) for the diesel generated by each subsystems 126-130, which are MVs for the main predictive controller 236 but CVs for the subsystem-specific predictive controllers 236 for subsystems 126-130. The subsystem-specific predictive controllers 236 may then use the target values for the diesel to be produced by their respective subsystems 126-130 as setpoints or targets for the CVs to be achieved by operating their respective subsystems 126-130. Additional detail regarding the hierarchical or cascaded structure of the subsystem-specific predictive controllers 236 and main predictive controller 236 is provided with reference to FIGS. 3-12.

In various embodiments, predictive controllers 236 may include neural network controllers such as deep learning controllers (DLCs), optimization-based controllers such as model predictive controllers (MPCs), or any other type of controller configured to generate values of the MVs based on the current state of plant 210. Several examples of different types of neural network controllers and optimization-based controllers which can be used as predictive controllers 236 are described in detail in the '227 application incorporated by reference above. The processes for training and using predictive controllers 236 to generate values of the MVs may vary depending on whether predictive controllers 236 are implemented as neural network controllers or optimization-based controllers.

For embodiments in which predictive controllers 236 are implemented as optimization-based controllers, predictive controllers 236 may use predictor models 232 and reward function evaluator 234 to generate a set of MVs that optimize the reward function J. For example, predictive controllers 236 may use predictor models 232 to predict the values of the CVs that would result from a given trajectory of the MVs over a given time period (e.g., a timeseries of the MVs for each time step within the time period), shown in FIG. 2 as “proposed MVs.” The predicted values of the CVs can be provided as inputs to reward function evaluator 234, which uses the predicted values of the CVs to calculate the value of the reward function/expected to result from the proposed MVs. Predictive controllers 236 may adjust the set of proposed MVs (e.g., using an iterative optimization process) until the values of the CVs and the resulting value of the reward function/have been sufficiently optimized and may provide the resulting set of MVs as outputs to plant 210.

For embodiments in which predictive controllers 236 are implemented as neural network controllers, predictive controllers 236 can be trained over multiple episodes (i.e., time windows) using the historical states from historical database 230. The training process may include providing the historical states of plant 210 as inputs to predictive controllers 236 (e.g., as inputs to the controller neural networks) and generating values of the MVs as outputs of predictive controllers 236 (e.g., as outputs of the controller neural networks). Predictor models 232 can be used to predict the values of the CVs that will result from the values of the MVs generated by predictive controllers 236 and reward function evaluator 234 can be used to evaluate the value of the reward function/that will result from the predicted values of the CVs. Predictive controllers 236 can then be updated or tuned (e.g., by adjusting the weights, biases, and/or other parameters of the controller neural networks) such that predictive controllers 236 learn to generate values of the MVs that optimize the reward function J. The training process for predictive controllers 236 when implemented as neural networks is described in greater detail with reference to FIG. 4. Plant 210 may receive the MVs from predictive controllers 236 and use the MVs to operate equipment 212.

In some embodiments, the values of the DVs are provided as inputs to plant controller 220 as part of the system state of plant 210. For example, one or more of the DVs may represent a measurable disturbance (e.g., outside air temperature, input oil quality, etc.) which can be measured by sensors 214 and provided to plant controller 220 as an input from plant 210. In some embodiments, plant controller 220 is configured to predict or forecast values of the DVs over a future time period for use in predictor models 232 and/or by predictive controllers 236. For example, other DVs may represent unmeasurable disturbances which cannot be directly observed by sensors 214 but can be predicted by plant controller 220. Plant controller 220 can use any of a variety of predictive models to predict values of the DVs for each time step and can provide the values of the DVs as inputs to predictor models 232.

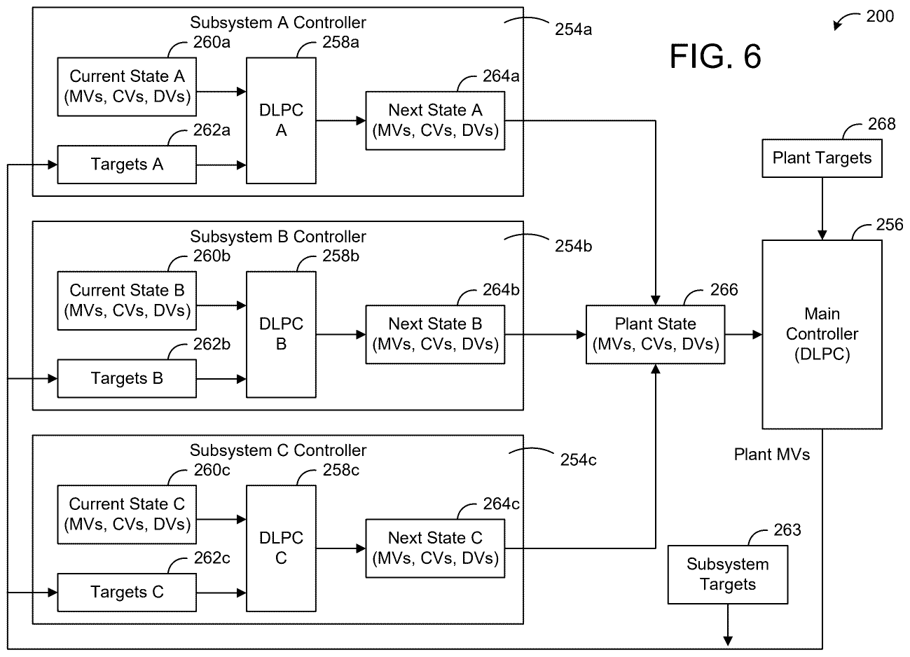

Plant controller 220 can execute any of a variety of control schemes that use predictor models 232 and/or predictive controllers 236 for online control of plant 210. One example of such a control scheme is the model predictive control (MPC) scheme described in the '227 application incorporated by reference above. See FIGS. 5-6 of the '227 application and the description thereof for a detailed example of a MPC scheme which can be used by plant controller 220 in some embodiments. However, it should be understood that plant controller 220 can use any of a variety of control schemes in various other embodiments. For example, plant controller 220 can use a neural network control scheme such as any of the neural network embodiments described in the '227 application. See FIGS. 7-20 of the '227 application and the description thereof for detailed examples of various neural network control schemes which can be used by plant controller 220.

Some of the neural network control schemes which can be used by plant controller 220 can generally be referred to as deep learning process control (DLPC) schemes. Some DLPC schemes may use a predictor (e.g., predictor models 232) online such as the MPC scheme discussed above, whereas other DLPC schemes may use a predictor offline for training a controller neural network. An online predictor can receive the MVs generated by an online controller (e.g., an instance of predictive controller 236) based on the current state of plant 210 and predict the values of the CVs at the next time step based on the MVs generated by the online controller. Conversely, an offline predictor can operate on historical states of plant 210 and can predict the values of the CVs for use in training a controller neural network (e.g., an instance of predictive controllers 236). The controller neural network can be trained offline and then used online to operate plant 210. An example of using an offline predictor to train a controller neural network is described in greater detail with reference to FIG. 4. For embodiments in which plant controller 220 uses a predictor offline to train a controller neural network, the training of the controller neural network may be performed using historical data where the disturbance values are known. Accordingly, the trained controller neural network in a DLPC scheme may have learned to account for future disturbance changes and thus may effectively include a disturbance forecaster within. It should be understood that plant controller 220 can use a control scheme with an online predictor, a control scheme with an offline predictor, or any other control scheme in various embodiments and that all such embodiments are within the scope of the present disclosure. Predictor models 232 can be used as either an online or offline predictor in various embodiments. Predictor models 232 can be trained prior to use by predictor model trainer 240.

Predictor model trainer 240 may receive (e.g., obtain, gather, collect, etc.) the historical states from historical database 230 and may use the historical states to train predictor models 232. The model training process used by predictor model trainer 240 is described in greater detail with reference to FIG. 3. In some embodiments, the model training processes performed by predictor model trainer 240 occur offline, separate from the online operation of plant controller 220 (e.g., predictor model trainer 240 may be implemented as a separate component rather than being part of plant controller 220). In other embodiments, predictor model trainer 240 may be integrated with or otherwise combined with plant controller 220 (e.g., predictor model trainer 240 may be a component of plant controller 220) and the functions performed by predictor model trainer 240 may be performed by plant controller 220. Once the model training processes are completed, predictor model trainer 240 can provide the trained predictor models 232 to plant controller 220 for use during online operation. Providing the trained predictor models 232 may include providing a set of trained weights (e.g., model parameters, weights between neurons, etc.) which configure predictor models 232 for online operation.

In various embodiments, predictor models 232 and predictive controllers 236 can be used to perform online control of plant 210 as described above or can be used to predict the performance of plant 210 without requiring online control. For example, in an embodiment that does not require online control, predictor models 232 and predictive controllers 236 can still be trained and used as described throughout the present disclosure and used to predict values of the CVs and generate the values of the MVs respectively. However, the values of the MVs need not be provided to plant 210 and used to operate equipment 212. In this scenario, plant controller 220 may operate as a predictor without requiring closed loop control or online control of plant 210. Alternatively or additionally, the values of the MVs generated by plant controller 220 can be presented to a user (e.g., as recommendations) and may cause the user to take action to adjust equipment 212 of plant 210 without requiring automatic operation of equipment 212. In various embodiments, predictive controllers 236 can control the operation of plant 210 either directly by automatically operating equipment 212 or indirectly by providing recommendations to a user responsible for operating equipment 212.

### Predictor and Controller Training

Referring now to FIG. 3, a block diagram illustrating predictor model trainer 240 in greater detail is shown, according to an exemplary embodiment. The predictor model 232 shown in FIG. 3 may be any of the subsystem-specific predictor models or main predictor model described with reference to FIG. 2. In some embodiments, predictor model trainer 240 can be used to train the subsystem-specific predictor models first, followed by the main predictor model. Predictor model trainer 240 can be configured to train predictor model 232 through iterative episodes drawn from historical data to predict the values of the CVs at the next time step. For embodiments in which predictor model 232 is implemented as a neural network, training predictor model 232 may include training the weights and/or biases between neurons or layers of the neural network. In such embodiments, predictor model trainer 240 may be referred to as a neural network model trainer. Predictor model trainer 240 may receive the historical states from historical database 230 and output trained weights and/or biases to predictor model 232.

Predictor model trainer 240 is shown to include prediction error evaluator 242 and a model tuner 244. These components of predictor model trainer 240 may cooperate to generate and evaluate an error loss function that quantifies the error between the ground truth and the predictions generated by predictor model 232. In this context, the ground truth may include the historical values of the system states (i.e., the historical states shown in FIG. 3) stored in historical database 230. In some embodiments, the ground truth may further include physical relationships between the MVs, CVs, and DVs, as described in U.S. patent application Ser. No. 18/976,116 filed Dec. 10, 2024 (“the '116 application”), the entire disclosure of which is incorporated by reference herein. Predictor model trainer 240 may include some or all of the features or functionality of the predictor model trainer described in the '116 application in some embodiments.

The model training process performed by predictor model trainer 240 may seek to reduce or minimize the prediction error loss Lossₑᵣᵣₒᵣ. Prediction error evaluator 242 is shown receiving the predicted CVs from predictor model 232 and historical states from historical database 230. As noted above, the historical states may include the historical values of the MVs, CVs, and/or DVs at each of a plurality of historical time steps or during historical time windows (referred to herein as “episodes”). The values of the CVs in historical database 230 may be treated as the “actual” values of the CVs by prediction error evaluator 242 for purposes of evaluating the prediction error. The predicted values of the CVs provided as inputs to prediction error evaluator 242 may be the corresponding values of the CVs predicted by predictor model 232 for the same historical states. For example, in some embodiments, the historical values of the MVs, DVs, and/or CVs from historical database 230 for one or more historical time steps are provided as inputs to predictor model 232 and used to predict the resulting values of the CVs at the next time step.

Prediction error evaluator 242 may generate the prediction error loss Lossₑᵣᵣₒᵣ using any of a variety of error calculation techniques such as mean squared error (MSE), mean absolute error (MAE), root mean squared error (RMSE), or any other error calculation technique. For example, if MSE is used, prediction error evaluator 242 can calculate Lossₑᵣᵣₒᵣ as follows:

$${Loss}_{error} = \frac{1}{n} {\sum }_{i = 1}^{n} {( {CV}_{i} - \text{?} )}^{2}$$

where CVᵢ is the actual value of the ith CV at a given time (e.g., as indicated by the historical states), [symbol] is the predicted value of that same CV at the same time as predicted by predictor model 232, and n is the total number of samples of the CVs for which MSE is calculated. As another example, if MAE is used instead of MSE, prediction error evaluator 242 can calculate Lossₑᵣᵣₒᵣ as follows:

$${Loss}_{error} = \frac{1}{n} {{\sum }_{i = 1}}^{n} \vert {CV}_{i} - \text{?} \vert$$

where the absolute value of the error is used instead of the square of the error. These and/or other error calculation techniques can be used in various embodiments.

In some embodiments, prediction error evaluator 242 applies weights to one or more of the CVs when calculating Lossₑᵣᵣₒᵣ as shown in the following equations, which correspond to the MSE and MAE embodiments described above:

$$\begin{matrix}{Loss}_{error} = \frac{1}{n} {\sum }_{i = 1}^{n} {{w}_{i} ( {CV}_{i} - \text{?} )}^{2} \\ {Loss}_{error} = \frac{1}{n} {\sum }_{i = 1}^{n} {w}_{i} \vert {CV}_{i} - \text{?} \vert\end{matrix}$$

where wᵢ is the weight applied to the ith CV. In some embodiments, the weights indicate a relative importance of each CV in the calculation of Lossₑᵣᵣₒᵣ and can be defined or set by a user. In some embodiments, the weights are normalization factors that compensate for the relative scales or magnitudes of each CV. For example, the value of wᵢ may be inversely proportional to the value of CVᵢ (e.g., wᵢ=1/CVᵢ, wᵢ∝1/CVᵢ) to ensure that that the CVs with relatively larger magnitudes or scales do not disproportionately skew the calculation of Lossₑᵣᵣₒᵣ. In some embodiments, the weights effectively normalize the contributions of each CV to the overall value of Lossₑᵣᵣₒᵣ (e.g., convert the errors into percentage errors or other normalized errors) such that each CV has equal ability to affect the value of Lossₑᵣᵣₒᵣ.

In some embodiments, prediction error evaluator 242 calculates Lossₑᵣᵣₒᵣ based on the actual and predicted values of the CVs over a time period as shown in the following equations, which correspond to the MSE and MAE embodiments described above:

$$\begin{matrix}{Loss}_{error} = \frac{1}{n * h} {\sum }_{t = 1}^{h} {\sum }_{i = 1}^{n} {( {CV}_{it} - \text{?} )}^{2} \\ {Loss}_{error} = \frac{1}{n * h} {\sum }_{t = 1}^{h} {\sum }_{i = 1}^{n} \vert {CV}_{it} - \text{?} \vert\end{matrix}$$

where h is the length of the time horizon over which Lossₑᵣᵣₒᵣ is calculated (i.e., the number of time steps t in the time horizon), CVᵢₜ is the actual value of the ith CV at the tth time step, [symbol] is the predicted value of the ith CV at the tth time step, and the remaining variables are the same as described above.

In some embodiments, prediction error evaluator 242 can calculate Lossₑᵣᵣₒᵣ using both the weights wᵢ and the time periods as shown in the following two equations, which correspond to the MSE and MAE embodiments described above:

$$\begin{matrix}{Loss}_{error} = \frac{1}{n * h} {\sum }_{t = 1}^{h} {\sum }_{i = 1}^{n} {{w}_{i} ( {CV}_{it} - \text{?} )}^{2} \\ {Loss}_{error} = \frac{1}{n * h} {\sum }_{t = 1}^{h} {\sum }_{i = 1}^{n} {w}_{i} \vert {CV}_{it} - \text{?} \vert\end{matrix}$$

to ensure the value of Lossₑᵣᵣₒᵣ is both based on the normalized contributions of each CV and calculated based on the predicted and actual values of the CVs over a time period. In various embodiments, the same weights wᵢ can be used for all of the time step-specific values of the corresponding CVs (e.g., the same weight wᵢ can be applied to each value of CVᵢ₁, . . . , CVᵢₕ for all time steps 1 . . . h) or different weights can be used for each time step. For example, the weight wᵢ in the equations above can be replaced with a time step-specific weight wᵢₜ which applies to the ith CV at the tth time step, to allow the weights to vary across the time steps.

Prediction error evaluator 242 may provide the error loss Lossₑᵣᵣₒᵣ to model tuner 244 for use in tuning predictor model 232. Model tuner 244 may use any of a variety of model tuning techniques to adjust the weights of predictor model 232 in an effort to minimize the value of the error loss Lossₑᵣᵣₒᵣ. In some embodiments, model tuner 244 uses an iterative tuning process that includes adjusting the weights of predictor model 232, using predictor model 232 to generate the predicted values of the CVs, and evaluating the error loss Lossₑᵣᵣₒᵣ for each set of values of the weights. Model tuner 244 can continue adjusting the model weights using an iterative optimization technique (e.g., gradient descent) until the resulting value of the error loss Lossₑᵣᵣₒᵣ is sufficiently small or has been minimized according to predetermined optimization criteria (e.g., convergence criteria).

Referring now to FIG. 4, a block diagram illustrating a controller model trainer 238 for use in training predictive controller 236 is shown, according to an exemplary embodiment. Controller model trainer 238 can be used to train predictive controller 236 for embodiments in which predictive controller 236 is implemented as a neural network (e.g., DLPC embodiments) as described above. In such embodiments, predictive controller 236 may include a set of weights, biases, or other parameters of the neural network that configure predictive controller 236 to transform a system state (e.g., values of the CVs, MVs, and DVs at one or more times) into a corresponding control action (e.g., proposed MVs) to execute in response to that system state. The training process for predictive controller 236 may include training the weights, biases, or other parameters of the neural network to configure predictive controller to generate an optimal control action for a given system state.

The predictive controller 236 shown in FIG. 4 may be any of the subsystem-specific predictive controllers or main predictive controller described with reference to FIG. 2. In some embodiments, controller model trainer 238 can be used to train the subsystem-specific predictive controllers first, followed by the main predictive controller. The training process for predictive controller 236 may begin by initializing predictive controller 236 with an initial set of weights and biases and retrieving historical values of the system states (i.e., the historical states shown in FIG. 4) stored in historical database 230. One or more system states can be provided as inputs to predictive controller 236, which transforms the system states into a set of proposed MVs. The proposed MVs generated by predictive controller 236 can be provided as inputs to predictor model 232. Predictor model 232 may use the proposed MVs generated by predictive controller 236 in combination with the historical states from historical database 230 to predict the values of the CVs that would result from using the proposed MVs to control plant 210.

The predicted values of the CVs can then be provided as inputs to reward function evaluator 234, which uses the predicted values of the CVs to calculate the value of the reward function/expected to result from the proposed MVs. The reward function values can be provided as an input to controller model trainer 238, which updates the weights, biases, or other parameters of predictive controller 236 (shown as “weights/biases” in FIG. 4) such that predictive controller 236 learns to generate values of the MVs that optimize the reward function J. The training process illustrated in FIG. 4 can be repeated for multiple episodes of historical states from historical database 230 to ensure that predictive controller 236 learns to generate optimal values of the MVs over a range of different states of plant 210. The trained weights/biases can then be stored in predictive controller 236 to configure predictive controller 236 for use in online control of plant 210.

### Modular Systems and Predictive Control

Referring now to FIG. 5, a block diagram illustrating a portion of control system 200 in greater detail is shown, according to an exemplary embodiment. Control system 200 is shown as a modular control system including a main controller 256 and several subsystem controllers 254a, 254b, and 254c (collectively subsystem controllers 254). Each of subsystem controllers 254 may correspond to a subsystem of plant 210 (shown as subsystems 252a, 252b, and 252c, collectively subsystems 252) and may be configured to monitor and control the corresponding subsystem 252 of plant 210. In particular, subsystem A controller 254a may be configured to monitor and control subsystem A 252a, subsystem B controller 254b may be configured to monitor and control subsystem B 252b, and subsystem C controller 254c may be configured to monitor and control subsystem C 252c. Subsystems 252 may represent any controllable system or process in plant 210, for example subsystems 120-132 in oil refinery system 100.

Subsystem A controller 254a is shown to include a predictive controller 236a (an instance of predictive controllers 236) and a predictor model 232a (an instance of predictor models 232). In some embodiments, predictive controller 236a and predictor model 232a may be implemented as neural networks and trained as described with reference to FIGS. 2-4. Subsystem A controller 254a may function as a low level controller configured to monitor and control the operation of subsystem A 252a. For example, predictive controller 236a may receive the current state of subsystem A 252a (e.g., a set of MVs, CVs, and DVs for subsystem A 252a) as an input from subsystem A 252a. Predictive controller 236a may also receive the subsystem A targets as inputs from main controller 256. Predictive controller 236a may generate a set of MVs for subsystem A 252a based on the current state and targets. Predictive controller 236a may provide the set of MVs as an input to subsystem A 252a for use in controlling the equipment of subsystem A 252a. The MVs for subsystem A 252a can also be provided as an input to predictor model 232a and used by predictor model 232a to predict the next state of subsystem A 252a that will result from the MVs (shown as “subsystem A new state” in FIG. 5). Subsystem A controller 254a may provide the new state of subsystem A 252a as feedback to main controller 256.

Similarly, subsystem B controller 254b is shown to include a predictive controller 236b (an instance of predictive controllers 236) and a predictor model 232b (an instance of predictor models 232). In some embodiments, predictive controller 236b and predictor model 232b may be implemented as neural networks and trained as described with reference to FIGS. 2-4. Subsystem B controller 254b may function as a low level controller configured to monitor and control the operation of subsystem B 252b. For example, predictive controller 236b may receive the current state of subsystem B 252b (e.g., a set of MVs, CVs, and DVs for subsystem B 252b) as an input from subsystem B 252b. Predictive controller 236b may also receive the subsystem B targets as inputs from main controller 256. Predictive controller 236b may generate a set of MVs for subsystem B 252b based on the current state and targets. Predictive controller 236b may provide the set of MVs as an input to subsystem B 252b for use in controlling the equipment of subsystem B 252b. The MVs for subsystem B 252b can also be provided as an input to predictor model 232b and used by predictor model 232b to predict the next state of subsystem B 252b that will result from the MVs (shown as “subsystem B new state” in FIG. 5). Subsystem B controller 254b may provide the new state of subsystem B 252b as feedback to main controller 256.

Subsystem C controller 254c is shown to include a predictive controller 236c (an instance of predictive controllers 236) and a predictor model 232c (an instance of predictor models 232). In some embodiments, predictive controller 236c and predictor model 232c may be implemented as neural networks and trained as described with reference to FIGS. 2-4. Subsystem C controller 254c may function as a low level controller configured to monitor and control the operation of subsystem C 252c. For example, predictive controller 236c may receive the current state of subsystem C 252c (e.g., a set of MVs, CVs, and DVs for subsystem C 252c) as an input from subsystem C 252c. Predictive controller 236c may also receive the subsystem C targets as inputs from main controller 256. Predictive controller 236c may generate a set of MVs for subsystem C 252c based on the current state and targets. Predictive controller 236c may provide the set of MVs as an input to subsystem C 252c for use in controlling the equipment of subsystem C 252c. The MVs for subsystem C 252c can also be provided as an input to predictor model 232c and used by predictor model 232c to predict the next state of subsystem C 252c that will result from the MVs (shown as “subsystem C new state” in FIG. 5). Subsystem C controller 254c may provide the new state of subsystem C 252c as feedback to main controller 256.

Each of subsystem controllers 254a, 254b, and 254c may receive targets from main controller 256 and may operate their corresponding subsystems 252a, 252b, and 252c to achieve the targets provided by main controller 256. The targets provided by main controller 256 may specify target values or setpoints for CVs in subsystems 252. Alternatively, the subsystem targets may be provided by a different data source (e.g., a site definition) rather than from main controller 256. Subsystem controllers 254 may operate the equipment of their respective subsystems 252 (e.g., by adjusting the MVs provided as inputs to subsystems 252) in an effort to drive the values of their respective CVs toward the targets provided by main controller 256. The actual or predicted values of the CVs for each subsystem can be provided as feedback from subsystem controllers 254 to main controller 256. Although only three subsystems 252 and three subsystem controllers 254 are shown in FIG. 5 for ease of illustration, it is contemplated that any number of subsystems 252 and subsystem controllers 254 can be present in system 200 in various embodiments. Advantageously, main controller 256 can be configured to accommodate any number of subsystems 252 in the modular control strategy described herein.

Main controller 256 may operate as a parent controller or supervisory controller for control system 200 and may provide targets to subsystem controllers 254. In various embodiments, main controller 256 can be implemented as a neural network (e.g., in a DLPC control scheme) or can use an optimization-based control strategy such as MPC. These embodiments are described in greater detail with reference to FIGS. 6-12. Main controller 256 may be an instance of predictive controllers 236 as described with reference to FIGS. 2-4. Main controller 256 can be configured optimize the operation of plant 210 as a whole by providing targets to subsystem controllers 254. The targets may be MVs in the high level control loop managed by main controller 256 and can be adjusted by main controller 256 to optimize the operation of plant 210. For example, main controller 256 may adjust the targets in an effort to optimize a reward function for plant 210 as a whole, which may depend on the values of the CVs controlled by subsystem controllers 254. Main controller 256 may receive the states of subsystems 252 as feedback from subsystem controllers 254. The states of subsystems 252 may include the actual or predicted values of the CVs in each subsystem 252 resulting from the targets provided by main controller 256. The values of the CVs can be used by main controller 256 to evaluate the reward function for plant 210 as a whole.

In various embodiments, the subsystems 252 shown in FIG. 5 may be arranged in parallel and/or in series with each other in plant 210. For example, the outputs of subsystem A 252a may feed into subsystem 252b or into both subsystem B 252b and subsystem C 252c in parallel. Subsystems B 252b and C 252c may operate in parallel and may both receive outputs from subsystem A 252a. As one example of such an arrangement, subsystem A 252a may represent distillation subsystem 120 in oil refinery system 100, whereas subsystems B 252b and C 252c may represent any of diesel hydrotreater subsystem 126, fluid catalytic cracking subsystem 128, hydrocracking subsystem 130, and/or coker subsystem 132 in oil refinery system 100. As another example, outputs of subsystem A 252a may feed into subsystem B 252b and the outputs of subsystem B 252b may feed into subsystem C252c in series. It is contemplated that any parallel, series, or combination of parallel and series arrangements can be used to construct plant 210 from interconnected subsystems 252.

As noted above, control system 200 can be constructed as a modular system including multiple interconnected subunits (i.e., subsystems 252) with specific control needs. Subsystem controllers 254 and main controller 256 may use models of subsystems 252 to predict future states and optimize control actions based on those predictions. However, modular systems introduce complexity in terms of communication delays, subunit interactions, and chain of actions, all of which must be addressed for effective control. The following sections of the present disclosure describe various system architectures and methods for controlling a modular system to address these challenges.

### Hierarchical Deep Learning Process Control

Referring now to FIG. 6, a block diagram illustrating a portion of control system 200 in greater detail is shown, according to an exemplary embodiment. In FIG. 6, control system 200 is shown as a hierarchical deep learning process control (DLPC) system including main controller 256 and several subsystem controllers 254a, 254b, and 254c (collectively subsystem controllers 254). Similar to the embodiment described with reference to FIG. 5, each of subsystem controllers 254a, 254b, and 254c corresponds to a particular subsystem of plant 210 (e.g., subsystems 252a, 252b, and 252c respectively) and is configured to monitor and control the corresponding subsystem. Main controller 256 may operate as a parent controller or supervisory controller for control system 200 as a whole or plant 210 as a whole and may provide targets to subsystem controllers 254.

Each of subsystem controllers 254a, 254b, and 254c is shown to include a deep learning process controller, shown as DLPC A 258a, DLPC B 258b, and DLPC C 258c respectively (collectively DLPCs 258). In some embodiments, each of DLPCs 258 may include an instance of predictive controllers 236 and predictor models 232. For example, DLPC A 258a may include predictive controller 236a and predictor model 232a, DLPC B 258b may include predictive controller 236b and predictor model 232b, and DLPC C 258c may include predictive controller 236c and predictor model 232c, which may be the same as described with reference to FIG. 5. In the hierarchical DLPC embodiment of FIG. 6, main controller 256 may also include an instance of predictive controllers 236 and predictor models 232. Each instance of predictive controllers 236 and predictor models 232 may be trained and operated in the manner described with reference to FIGS. 2-5. For example, each instance of predictive controllers 236 can be configured to generate a set of proposed MVs based on the current state of the respective subsystem (e.g., current states 260) or plant (e.g., plant state 266). Each instance of predictor models 232 can then predict the next state of the respective subsystem or plant based on the proposed MVs generated by the corresponding instance of predictive controllers 236. In some embodiments, DLPCs 258 of subsystem controllers 254 are trained first and then main controller 256 is trained using inputs from subsystem controllers 254.

In some embodiments, each of DLPCs 258 and main controller 256 includes an instance of predictive controllers 236 but does not include an instance of predictor models 232. For example, in some embodiments, each of DLPCs 258 and main controller 256 are trained offline by performing the training processes described with reference to FIGS. 2-5. The training processes may include using predictor models 232 offline to produce trained instances of predictive controllers 236. The trained instances of predictive controllers 236 can then be used online to generate a set of MVs based on the current states provided as inputs to predictive controllers 236. Specifically, the trained instance of predictive controllers 236 within DLPC A 258a may be configured to generate a set of MVs for subsystem A 252a based on the current state 260a of subsystem A 252a. Similarly, the trained instance of predictive controllers 236 within DLPC B 258b may be configured to generate a set of MVs for subsystem B 252b based on the current state 260b of subsystem B 252b, and the trained instance of predictive controllers 236 within DLPC C 258c may be configured to generate a set of MVs for subsystem C 252c based on the current state 260c of subsystem C 252c. The trained instances of predictive controllers 236 can be deployed to DLPCs 258 and to main controller 256 after the training processes are complete for use during online operation of plant 210.

Still referring to FIG. 6, main controller 256 is shown receiving plant targets 268 as an input. Plant targets 268 include target values for main controller 256 such as target values for the MVs and CV affected by main controller 256, prices for the reward function J, or any other targets which main controller 256 seeks to achieve by operating plant 210. In some embodiments, plant targets 268 may include constraints on any of the MVs or CVs in plant 210, target values for any of the MVs, CVs, or DVs, and/or a reward function/based on the values of the MVs, CVs, and/or DVs for plant 210. In some embodiments, the reward function J is the same as or similar to the reward function described with reference to FIG. 2. For example, the reward function/may quantify the performance of plant 210 as a whole as a function of the CVs (and in some cases other variables in addition to the CVs) and may define one or more objectives which main controller 256 seeks to minimize or maximize.

Main controller 256 is also shown receiving a plant state 266 as an input. Plant state 266 may represent the state of plant 210 at a given time or over a given time period (e.g., a time window). Plant state 266 may include a set of values for the MVs, CVs, and DVs of plant 210 at one or more times leading up to the current time. In some embodiments, plant state 266 is the current state of plant 210. Plant state 266 may be provided as an input to the instance of predictive controllers 236 within main controller 256 in the same manner as the current state of plant 210 is provided to predictive controllers 236 in FIG. 2. Main controller 256 can be configured to generate a set of MVs for plant 210 as a whole (shown as “plant MVs” in FIG. 6) based on the plant state 266. The instance of predictor models 232 within main controller 256 may be configured to predict the next plant state (e.g., the value of plant state 266 at the next time step) based on the current value of plant state 266 and the plant MVs. In various embodiments, main controller 256 can use the plant state 266 provided as an input by subsystem controllers 254 or can predict the plant state 266 using an instance of predictor models 232 within main controller 256. In some embodiments, the set of plant MVs includes target values for the CVs in subsystems 252.

Subsystem controllers 254 are shown receiving the plant MVs from main controller 256 and storing the plant MVs as targets 262. Specifically, subsystem A controller 254a may receive a set of targets 262a for subsystem A 252a, subsystem B controller 254b may receive a set of targets 262b for subsystem B 252b, and subsystem C controller 254c may receive a set of targets 262c for subsystem C 252c. Each set of targets 262a, 262b, and 262c (collectively targets 262) may include target values for the CVs affected by operating the corresponding subsystems 252a, 252b, and 252c of plant 210. For example, targets 262a may include targets for one or more CVs affected by operating the equipment of subsystem 252a, targets 262b may include targets for one or more CVs affected by operating the equipment of subsystem 252b, and targets 262c may include targets for one or more CVs affected by operating the equipment of subsystem 252c. In some embodiments, targets 262 also include one or more constraints, optimization goals, reward functions J, or other information similar to plant targets 268. However, unlike plant targets 268 which are applicable to plant 210 as a whole, each instance of targets 262 may be specific to a particular subsystem 252. In some embodiments, main controller 256 provides subsystem controllers 254 with targets 262 that include target values of the subsystem CVs (i.e., the CVs affected by operating equipment of subsystems 252), whereas other subsystem targets 263 can be provided by an external source (e.g., an outside system or device, a user, a supervisory control system, etc.). Subsystem targets 263 can include any other targets used by subsystem controllers 254 other than the plant MVs provided by main controller 256.

Subsystem controllers 254 may use targets 262 in the same manner as main controller 256 uses plant targets 268. For example, DLPCs 258 may use targets 262 in combination with the current states 260 of subsystems 252 to generate a set of MVs for each subsystem 252. Specifically, DLPC A 258a may use targets 262a (i.e., targets for subsystem A 252a) to generate a set of MVs which can be used to operate the equipment of subsystem A 252a. Similarly, DLPC B 258b may use targets 262b (i.e., targets for subsystem B 252b) to generate a set of MVs which can be used to operate the equipment of subsystem B 252b, whereas DLPC C 258c may use targets 262c (i.e., targets for subsystem C 252c) to generate a set of MVs which can be used to operate the equipment of subsystem C 252c.

The MVs generated by each of DLPCs 258 are provided as inputs to their respective subsystems 252, causing a change in the states of subsystems 252. The updated or new states of subsystems 252 (shown as next state A 264a, next state B 264b, and next state C 264c, collectively next states 264) include the actual or predicted values of the MVs, CVs, and/or DVs for each of subsystems 252 as a result of applying the MVs generated by DLPCs 258 to their respective subsystems 252. The next states 264 of the various subsystems 252 combine to form plant state 266 (i.e., the state of plant 210 as a whole), which is provided as a feedback to main controller 256 for use in generating the next values of the plant MVs. The entire process described with reference to FIG. 6 can then be repeated to continue generating updated targets 262 and updated MVs for subsystems 252 during online operation of plant 210.

In the modular control embodiment of FIG. 6, main controller 256 operates as a parent or supervisory controller for plant 210 as a whole, whereas each of subsystem controllers 254 operate as a child or lower level controller for a specific subsystem 252. Main controller 256 may treat each subsystem controller 254 as a low level control loop (e.g., a PID) in the sense that each subsystem controller 254 controls its respective subsystem 252 to meet the targets 262 provided by main controller 256. From the perspective of main controller 256, the MVs adjusted by main controller are targets 262 for subsystem controllers 254. Each of subsystem controllers 254a, 254b, and 254c has its own set of targets 262a, 262b, and 262c respectively which are set by main controller 256. Each set of targets 262 may include target values of the CVs affected by the corresponding subsystem 252 and/or constraints on the MVs, CVs, or DVs applicable to the corresponding subsystem 252. Each of subsystem controllers 254 may operate the corresponding subsystem 252 in an effort to achieve the target values of the CVs for that subsystem 252 provided by main controller 256. In some embodiments, each of subsystem controllers 256 may seek to achieve a subsystem-specific control objective based on the target values of the CVs for that subsystem 252 provided by main controller 256 (e.g., reduce or minimize error between the CV targets and actual or predicted values of the CVs) and/or may operate the corresponding subsystem 252 based on constraints on the CVs for that subsystem 252 provided by main controller 256.

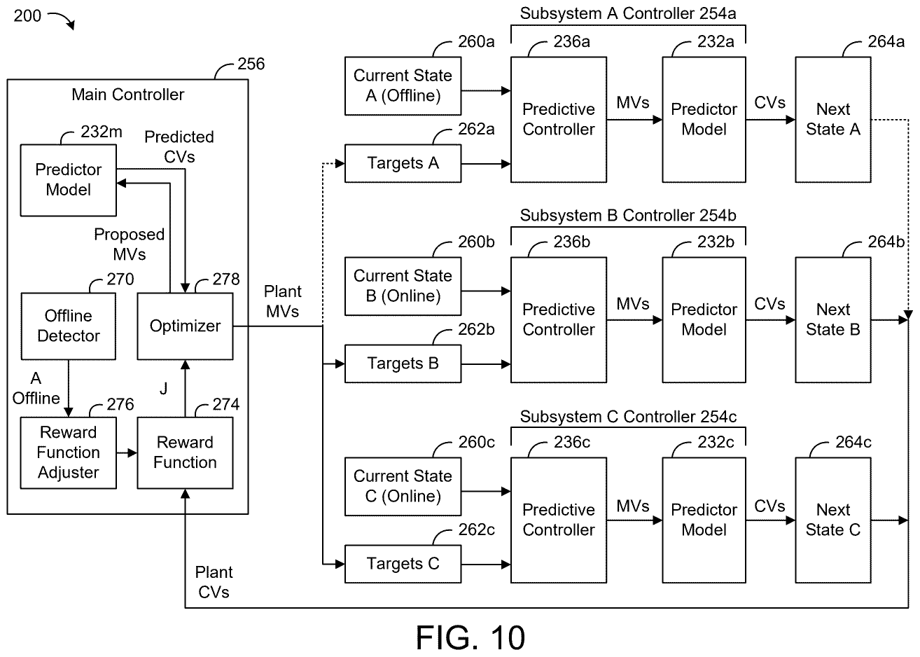

Referring now to FIG. 7, several graphs 302-320 illustrating the functionality of main controller 256, subsystem A controller 254a, and subsystem B controller 254b are shown, according to an exemplary embodiment. Although only two subsystem controllers 254a and 254b are shown for ease of illustration, it is contemplated any number of subsystem controllers 254 can be included to monitor and control each of the subsystems 252 of plant 210. The functionality illustrated in FIG. 7 is applicable to the hierarchical DLPC embodiment shown in FIG. 6, but can also be used in other embodiments of the present disclosure, such as the mesh optimizer embodiment described with reference to FIGS. 10-12.

In the example shown in FIG. 7, main controller 256 operates to adjust the values of two high level MVs, shown as MV H1 in graph 302 and MV H2 in graph 304. In the context of oil refinery system 100, the variables MV H1 and MV H2 may represent, for example, targets for the amounts or qualities of diesel produced by diesel hydrotreater subsystem 126 and hydrocracking subsystem 130 respectively. These two variables MV H1 and MV H2 are MVs from the perspective of main controller 256 and can be adjusted by main controller 256 to optimize the value of a high level reward function Jₕ used by main controller 256. For example, main controller 256 may cause the value of MV H1 to ramp upward over a first time period and then hold constant for the second portion of the time period, as shown in graph 302. Conversely, main controller 256 may cause the value of MV H2 to ramp downward over a first time period and then hold constant for the second portion of the time period, as shown in graph 304.

The values of the high level reward function Jₕ resulting from these values of MV H1 and MV H2 are shown in graph 306. In the context of oil refinery system 100, the high level reward function Jₕ may quantify, for example, the total amount or value of diesel added to diesel pool 134 by subsystems 126-130. The high level reward function Jₕ may be a function of CVs and/or DVs representing the amounts or values of diesel added to diesel pool 134 by each of subsystems 126-130, which can be affected by adjusting the high level MVs MV H1 and MV H2. The control operations performed by main controller 256 are subject to a constraint indicated by the dashed line in graph 308. The constraint may specify an upper bound on a MV, CV, or function thereof. For example, the constraint may represent a maximum capacity of one or more of tanks 110-118 in system 100 which cannot be exceeded. Main controller 256 may adjust the values of MV H1 and MV H2 to maximize the high level reward function Jn subject to the constraint.

Subsystem A controller 254a receives the values of MV H1 as an input from main controller 256 and uses the values of MV H1 as targets 262a. From the perspective of subsystem A controller 254a, the variable MV H1 (e.g., the amount or quality of diesel produced by diesel hydrotreater subsystem 126) is not a MV because it cannot be adjusted directly by subsystem A controller 254a, but rather is a CV (shown as CV A in graph 310) which can be affected by operating the equipment of subsystem 252a. The dashed line in graph 310 represents the target values of CV A specified by main controller 256, which may be the same as the values of MV H1. The solid line in graph 310 represents the actual or predicted values of CV A over the time period. Subsystem A controller 254a directly adjusts the values of MV A shown in graph 312 (e.g., temperatures, pressures, flow rates, etc. used to control equipment of hydrotreater subsystem 126) which affects the values of CV A over the time period. Subsystem A controller 254a may seek to optimize the value of the subsystem A objective shown in graph 314. In some embodiments, the value of the subsystem A objective is the value of the reward function JA specific to subsystem A 252a. For example, the reward function JA may represent the error between the target value of CV A provided by main controller 256 (i.e., the values of MV H1) and the actual or predicted values of CV A in subsystem 252a.

Similarly, subsystem B controller 254b receives the values of MV H2 as an input from main controller 256 and uses the values of MV H2 as targets 262b. From the perspective of subsystem B controller 254b, the variable MV H2 (e.g., the amount or quality of diesel produced by hydrocracking subsystem 130) is not a MV because it cannot be adjusted directly by subsystem B controller 254b, but rather is a CV (shown as CV B in graph 316) which can be affected by operating the equipment of subsystem 252b. The dashed line in graph 316 represents the target values of CV B specified by main controller 256, which may be the same as the values of MV H2. The solid line in graph 316 represents the actual or predicted values of CV B over the time period. Subsystem B controller 254b directly adjusts the values of MV B shown in graph 318 (e.g., temperatures, pressures, flow rates, etc. used to control equipment of hydrocracking subsystem 130) which affects the values of CV B over the time period. Subsystem B controller 254b may seek to optimize the value of the subsystem B objective shown in graph 320. In some embodiments, the value of the subsystem B objective is the value of the reward function JB specific to subsystem B 252b. For example, the reward function JB may represent the error between the target value of CV B provided by main controller 256 (i.e., the values of MV H2) and the actual or predicted values of CV B in subsystem 252b.

One advantage that arises from the hierarchical DLPC structure is the ability of main controller 256 to handle common constraints when optimizing the high level objective shown in graph 306. For example, main controller 256 can be configured to calculate an inferential (i.e., a calculated or derived variable) based on the states of subsystems 252 (i.e., the values of the MVs, CVs, and/or DVs for each subsystem 252) which may be subject to the high level constraint shown in graph 308. In some embodiments, the states of subsystems 252 are updated at a first frequency or time interval corresponding to a time step of the subsystem-specific control processes executed by subsystem controllers 254. Main controller 256 can use the states of subsystems 252 to calculate the values of a variable which is sampled less frequently (i.e., at a second frequency slower than the first frequency or at a second time interval longer than the first time interval). Advantageously, this allows main controller 256 to generate higher resolution values of the calculated variable (i.e., at more granular or frequent time steps) than would be possible if the variable were only sampled at the first (slower) frequency.

Another advantage that arises from the hierarchical DLPC structure is the ability of control system 200 to handle high model complexity. The model complexity of neural network models increases significantly when scaling to multiple subsystems 252, often resulting in models that are too large and inefficient. Moreover, the process dynamics of a higher level controller that monitors and controls multiple subsystems 252 (e.g., main controller 256) are longer than in a lower level controller for a single subsystem (e.g., subsystem controllers 254) because the higher level controller is involved with multiple subsystems 252, which may be located in different positions in plant 210. Advantageously, the hierarchical DLPC structure allows control system 200 to address the increased complexity of a larger neural network model (e.g., a model for plant 210 as a whole) by decomposing it into several sub-models (e.g., subsystem-specific models for each of subsystems 252).

Additionally, because main controller 256 operates a higher level or supervisory control process above subsystem controllers 254, main controller 256 can have a longer step size (i.e., time step duration) to support long delays that may exist between subsystems 252. For example, the lower level control processes for subsystems 252 may have a step size of Δt_{L} (e.g., one minute, five minutes, etc.) which defines the interval or frequency at which each iteration of the subsystem-specific control processes executed by subsystem controllers 254 are performed. Conversely the higher level control process executed by main controller 256 may have a step size of Δt_{H} (e.g., fifteen minutes, one hour, etc.) which defines the interval or frequency at which each iteration of the higher level control process executed by main controller 256 is performed, where Δt_{H}>Δt_{L}.

Another advantage that arises from the hierarchical DLPC structure is the ability of control system 200 to handle intermittent shutdowns of subsystems 252 (referred to herein as “subsystem shutdowns” or “subunit shutdowns”) without affecting the ability of main controller 256 to provide optimal targets 262 to subsystems 252. For example, in a plant 210 with multiple subsystems 252, it is possible that some subsystems 252 might go offline from time to time, leading to spurious values of the subsystem-specific states 264 (i.e., values of the MVs, CVs, and/or DVs specific to that subsystem) that combine to form the plant state 266. This poses difficulties in encoding the states of subsystems 252 to the neural network used by main controller 256. As neural networks generally have trouble handling cases of missing inputs, this could disrupt the predictive accuracy and control capabilities of main controller 256 in the absence of a solution to handle this operational complexity. Advantageously, the systems and methods described herein address this issue by training main controller 256 to handle scenarios in which one or more of subsystems 252 and/or subsystem controllers 254 are offline. This is accomplished by training the instance of predictor models 232 within main controller 256 to predict the next state of plant 210 with and without the variables of the offline subsystems 252 and/or subsystem controllers 254 (e.g., with and without various combinations of the next states 264a, 264b, and 264c).

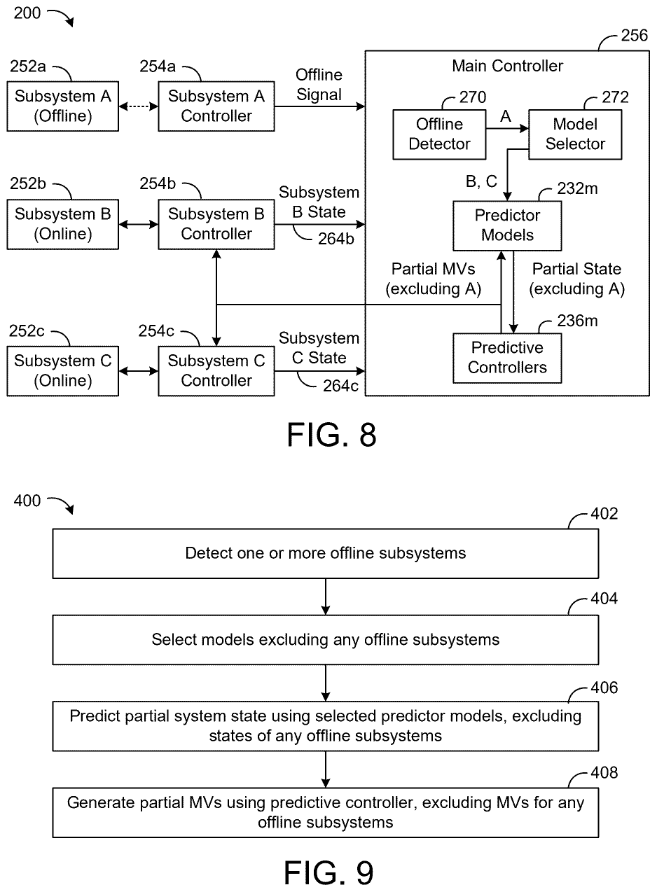

Referring now to FIG. 8, a block diagram illustrating the ability of control system 200 to adapt to offline subsystems 252 is shown, according to an exemplary embodiment. In the scenario illustrated in FIG. 8, subsystem A 252a is offline (e.g., shutdown, malfunctioned, stopped communicating, etc.) and cannot be actively controlled by subsystem A controller 254a. Subsystem A controller 254a may be configured to detect that subsystem A 252a is offline and may provide an offline signal to main controller 256 indicating that subsystem A 252a is offline. In some embodiments, subsystem A controller 254a provides the offline signal to main controller 256 instead of reporting the state 264a of subsystem A 252a. Conversely, subsystem B 252b and subsystem C 252c are online and operating normally in the scenario illustrated in FIG. 8. Subsystem B controller 254b and subsystem C controller 254c can operate subsystem B 252b and subsystem C 252c as usual and may provide the states 264b and 264c of subsystem B 252b and subsystem C 252c respectively as inputs to main controller 256. Although only one subsystem is shown as offline in FIG. 8, it is contemplated that any number of subsystems 252 can be offline inv various scenarios.

Main controller 256 is shown to include an offline detector 270 and a model selector 272. Offline detector 270 can be configured to detect which of subsystems 252 are offline based on the signals received from subsystem controllers 254 and provide an indication of the offline subsystems to model selector 272. Model selector 272 can be configured to select one or more models for main controller 256 to use based on the online/offline statuses of subsystems 252. The selected models may include variables that apply to the online subsystems 252 and exclude any variables that are specific to the offline subsystems 252. For example, in the scenario illustrated in FIG. 8, model selector 272 may select one or more models that can be used to predict and/or control subsystem B 252b and subsystem C 252c, but exclude subsystem A 252a because subsystem A 252a is offline. Accordingly, model selector 272 is shown selecting models associated with subsystem B 252b and subsystem C 252c. The selected models (e.g., instances of predictor models 232 and/or predictive controllers 236) can be trained using only the system states and variables associated with the corresponding subsystems 252 and may be configured to output values of CVs and/or MVs associated with only the corresponding subsystems 252.

In some embodiments, a single model (e.g., a single instance of predictor models 232 and/or predictive controllers 236) can be configured to handle multiple different control scenarios, where each control scenario corresponds to a different combination of subsystems 252 being offline or otherwise uncontrollable. The single model can be trained to operate in different modes corresponding to the different control scenarios, for example by providing the model with flags or other inputs that indicate the particular control scenario for each training episode during model training. After training is complete, the single model can then be operated in the different modes (e.g., switched between different operating modes) by providing the model with inputs or flags that indicate the active control scenario. Accordingly, the description provided herein of model selector 272 selecting one or more models should be understood as encompassing both (i) a first embodiment in which model selector 272 selects a particular model from a set of discrete models each configured to handle a different control scenario, as described above, and (ii) a second embodiment in which model selector 272 selects a particular mode in which to operate a single model configured to handle multiple different control scenarios. Similarly, any description provided herein of selecting a first model or a second model or changing from using a first model to using a second model should be understood as encompassing both (i) a first embodiment in which different discrete models are selected or used and (ii) a second embodiment in which different modes of a single model are selected or used. For example, any description provided herein of selecting a first predictive controller or a second predictive controller or changing from using a first predictive controller to using a second predictive controller should be understood as encompassing both (i) a first embodiment in which different discrete predictive controllers are selected or used and (ii) a second embodiment in which different operating modes of a single predictive controller are selected or used.

Main controller 256 is shown to include predictor models 232m and predictive controllers 236m. Predictor models 232m may include one or more instances of predictor models 232 used by main controller 256. Each of predictor models 232m may correspond to a combination of subsystems 252 (e.g., a set of online subsystems 252) and may be configured to predict the CVs of the corresponding subsystems 252 based on the current state of plant 210 and/or a set of proposed MVs generated by predictive controllers 236m. Some instances of predictor models 232m may exclude one or more subsystems 252 (e.g., any offline subsystems 252) and may not include any variables specific to the excluded subsystems 252. For example, in the scenario illustrated in FIG. 8, predictor models 232m may include a model configured to predict the CVs associated with subsystem B 252b and subsystem C 252c, but excluding the CVs associated with subsystem A 252a. The output of predictor models 232m is shown as a “partial state” in FIG. 8 because it excludes CVs associated with any offline subsystems 252.

In some embodiments, predictor models 232m includes a separate predictor model for each combination of online subsystems 252. For example, predictor models 232m may include a first predictor model for the combination of subsystem A 252a and subsystem B 252b online and subsystem C 252c offline, a second predictor model for the combination of subsystem A 252a and subsystem C 252c online and subsystem B 252b offline, a third predictor model for the combination of subsystem B 252b and subsystem C 252c online and subsystem A 252a offline, a fourth predictor model for the combination of subsystem A 252a online and subsystem B 252b and subsystem C 252c offline, a fifth predictor model for the combination of subsystem B 252b online and subsystem A 252a and subsystem C 252c offline, a sixth predictor model for the combination of subsystem C 252c online and subsystem A 252a and subsystem B 252b offline, and a seventh predictor model for the combination of all three subsystems 252a, 252b, and 252c online. Each instance of predictor models 232m can be trained using only the states 264 of the corresponding online subsystems 252 and can be configured to predict the CVs of the corresponding online subsystems 252, excluding the CVs of any offline subsystems 252.

In some embodiments, predictor models 232m may include a single predictor model 232m configured to predict the CVs of all subsystems 252 including both offline and online subsystems 252. However, the single predictor model 232m may be configured to hold the CVs for any offline subsystems 252 at constant values in response to offline detector 270 determining that the subsystems 252 are offline. In this scenario, the partial state generated by predictor models 232m may include a constant portion that corresponds to the offline subsystems 252 and a variable portion that corresponds to the online subsystems 252. Advantageously, this approach (i.e., holding the states of any offline subsystems 252 constant) ensures that the partial state generated by predictor models 232m includes values for all of the variables used to define the complete state of plant 210 even if some of those variables correspond to offline subsystems 252. The partial states predicted by predictor models 232m can be provided as inputs to predictive controllers 236m.

Predictive controllers 236m may include an instance of predictive controllers 236 used by main controller 256. Each of predictive controllers 236m may correspond to a combination of subsystems 252 (e.g., a set of online subsystems 252) and may be configured to generate a set of MVs for the corresponding subsystems 252 based on the partial state of plant 210 provided by predictor models 232m. Some instances of predictive controllers 236m may exclude one or more subsystems 252 (e.g., any offline subsystems 252) and may not generate any MVs specific to the excluded subsystems 252. For example, in the scenario illustrated in FIG. 8, predictive controllers 236m may include a model configured to generate the MVs associated with the online subsystem B 252b and online subsystem C 252c, but excluding the MVs associated with the offline subsystem A 252a. The output of predictive controllers 236m is shown as “partial MVs” in FIG. 8 because it excludes MVs associated with any offline subsystems 252.

In some embodiments, predictive controllers 236m includes a separate predictor model for each combination of online subsystems 252. For example, predictive controllers 236m may include a first predictive controller for the combination of subsystem A 252a and subsystem B 252b online and subsystem C 252c offline, a second predictive controller for the combination of subsystem A 252a and subsystem C 252c online and subsystem B 252b offline, a third predictive controller for the combination of subsystem B 252b and subsystem C 252c online and subsystem A 252a offline, a fourth predictive controller for the combination of subsystem A 252a online and subsystem B 252b and subsystem C 252c offline, a fifth predictive controller for the combination of subsystem B 252b online and subsystem A 252a and subsystem C 252c offline, a sixth predictive controller for the combination of subsystem C 252c online and subsystem A 252a and subsystem B 252b offline, and a seventh predictive controller for the combination of all three subsystems 252a, 252b, and 252c online. Each instance of predictive controllers 236m can be trained using only the partial states 264 of the corresponding online subsystems 252 and can be configured to generate the MVs of the corresponding online subsystems 252, excluding the MVs of any offline subsystems 252.

In some embodiments, predictive controllers 236m may include a single predictive controller 236m configured to generate the MVs for all subsystems 252 including both offline and online subsystems 252. However, the single predictive controller 236m may be configured to hold the MVs for any offline subsystems 252 at constant values in response to offline detector 270 determining that the subsystems 252 are offline. In this scenario, the partial MVs generated by predictive controllers 236m may include a constant portion that corresponds to the offline subsystems 252 and a variable portion that corresponds to the online subsystems 252. The partial MVs generated by predictive controllers 236m can be provided as inputs to the corresponding set of subsystem controllers 254 for the online subsystems and used as target values for the CVs controlled by each subsystem controller 254.

Advantageously, the control technique illustrated in FIG. 8 allows main controller 256 to adapt to various subsystems 252 going offline temporarily while ensuring main controller 256 continues to produce optimal and numerically stable MVs for the remaining online subsystems 252. By detecting offline subsystems 252 and switching to a set of predictor models 232m and predictive controllers 236m specifically trained for a particular combination of online subsystems 252, main controller 256 can continue to control plant 210 by adjusting only the MVs that are controllable via the online subsystems 252 and excluding any MVs that cannot be adjusted because the corresponding subsystems 252 are offline. Alternatively, main controller 256 can use a single predictor model 232m and single predictive controller 236m trained to handle all subsystems 252, but configured to hold the CVs and MVs of any offline subsystems 252 at constant values until the subsystems 252 come back online. This adaptability ensures the efficacy of main controller 256 in managing the operations of plant 210 seamlessly, contributing to enhanced overall performance even when some subsystems 252 are offline.

Referring now to FIG. 9, a flowchart illustrating a process 400 which can be performed by control system 200 to adapt to offline subsystems 252 is shown, according to an exemplary embodiment. Process 400 can be performed by the components of control system 200 shown in FIG. 8. Process 400 is shown to include detecting one or more offline subsystems (step 402) and selecting models excluding any offline subsystems (step 404). These steps can be performed by offline detector 270 and model selector 272 as described with reference to FIG. 8. The models selected in step 404 may include instances of predictor models 232m and predictive controllers 236m specifically trained using only the system states and other variables associated with the online subsystems 252 and excluding any offline subsystems. Alternatively, the models selected in step 404 may include an instance of predictor models 232m and predictive controllers 236m trained using the system states and other variables associated with both online and offline subsystems 252, but configured to ignore or hold constant any variables associated with offline subsystems 252.

Process 400 is shown to include predicting a partial system state using the selected predictor models, excluding states of any offline subsystems (step 406). The partial system state predicted in step 406 may include a set of CVs associated with the online subsystems 252 but excluding any CVs associated with only the offline subsystems 252. Alternatively, the partial system state predicted in step 406 can include a portion that is held constant (e.g., for any offline subsystems 252) and a portion that is adjusted (e.g., for any online subsystems). The partial system state generated in step 406 can be provided as an input to predictive controllers 236m and used in step 408.

Process 400 is shown to include generating partial MVs using a predictive controller, excluding MVs for any offline subsystems (step 408). The partial MVs generated in step 408 may include a set of MVs associated with the online subsystems 252 but excluding any MVs associated with only the offline subsystems 252. Alternatively, the partial MVs generated in step 408 can include a portion that is held constant (e.g., for any offline subsystems 252) and a portion that is adjusted (e.g., for any online subsystems). The partial MVs generated in step 408 can be provided as inputs to subsystem controllers 254 for the online subsystems 252 and used as target values to control their respective subsystems 252.

### Mesh Optimizer

Referring now to FIG. 10, a block diagram illustrating a portion of control system 200 in greater detail is shown, according to an exemplary embodiment. In FIG. 10, control system 200 is shown as a mesh optimizer including main controller 256 and several subsystem controllers 254 (i.e., subsystem controllers 254a, 254b, and 254c). Each of the components shown in FIG. 10 can be considered a node in a graph-based representation of control system 200 in which the various components form a mesh including multiple routes or closed loops interconnecting main controller 256 with subsystem controllers 254.

Each of subsystem controllers 254a, 254b, and 254c corresponds to a particular subsystem of plant 210 (i.e., subsystems 252a, 252b, and 252c respectively) and is configured to monitor and control the corresponding subsystem 252. Each of subsystem controllers 254 may be the same as described with reference to FIGS. 6-9. For example, subsystem controllers 254 may be implemented as deep learning process controllers (DLPCs) and may each include an instance of predictive controllers 236 and predictor models 232. Subsystem A controller 254a is shown to include predictive controller 236a and predictor model 232a, subsystem B controller 254b is shown to include predictive controller 236b and predictor model 232b, and subsystem C controller 254c is shown to include predictive controller 236c and predictor model 232c. These components may operate the same as previously described with reference to the hierarchical DLPC embodiment of FIGS. 6-9.

Main controller 256 may operate as a parent controller or supervisory controller for control system 200 as a whole or plant 210 as a whole and may provide targets to subsystem controllers 254. In the mesh optimizer embodiment of FIG. 10, main controller 256 may include several of the same components as previously described. For example, main controller 256 is shown to include offline detector 270 which can be configured to detect which of subsystems 252 are offline. Main controller 256 is also shown to include a reward function 274, which may be the same as or similar to the reward function/described with reference to FIG. 2 and/or the high level reward function Jy described with reference to FIG. 7. For example, the reward function 274 shown in FIG. 10 may define a control objective/as a function of the plant CVs associated with the various subsystems 252 of plant 210.

In some embodiments, the value of the reward function 274 at a given time t is based on the values of the CVs at that same time t (e.g., Jₜ=ƒ(c_{1,t}, c_{2,t}> . . . , c_{n,t})), where n is the total number of CVs included in the reward function 274 and the variables c_{1,t}>c_{2,t}> . . . , c_{n,t} are the values of the CVs at time t. In other embodiments, the value of the reward function 274 may be based on the values of the CVs over a predetermined time period including multiple time steps t

$$( e . g . , J = {\sum }_{{t}^{′} = t}^{t + k} f ( {c}_{1 , t}^{′} , {c}_{2 , t}^{′} , … , {c}_{n , t}^{′} ) ) ,$$

where k is the total number of time steps t included in the time period over which the reward function 274 is evaluated. In some embodiments, the values of one or more of the MVs and/or DVs at one or more time steps can be included in the reward function 274 in addition to the values of the CVs.

However, unlike the hierarchical DLPC embodiment of FIGS. 6-9, the embodiment of main controller 256 shown in FIG. 10 may use model predictive control (MPC) to generate the targets 262 for subsystem controllers 254 rather than using a neural network control technique. For example, main controller 256 is shown to include a predictor model 232m and an optimizer 278. Predictor model 232m may be an instance of predictor models 232 as described with reference to FIG. 2 and may operate as a main predictor model for plant 210 as a whole. Predictor model 232m can be configured to predict the CVs of plant 210 as a whole (e.g., the amounts and/or qualities of each petroleum product provided as an output of plant 210) based on a set of proposed MVs generated by optimizer 278. In some embodiments, main controller 256 does not include or require predictor model 232m, but rather can use predictor models 232 of subsystem controllers 254 (e.g., predictor models 232a-232c) to predict the CVs of plant 210 as a whole. Optimizer 278 may be a particular type of predictive controllers 236 configured to generate the set of proposed MVs by performing an optimization-based control process, such as model predictive control.

Optimizer 278 may obtain values of the CVs, MVs, and/or DVs for each time step in the reward function 274 and use the values of the CVs, MVs, and/or DVs to calculate the value of the reward function 274. Optimizer 278 can be configured to adjust the proposed MVs and use predictor model 232m to predict the values of the CVs that will result from the proposed MVs. Optimizer 278 can evaluate reward function 274 using the predicted values of the CVs (and optionally values of any MVs or DVs included in the reward function 274) to determine the effect of the proposed MVs on the high level control objective defined by the reward function 274. Optimizer 278 can repeat these steps iteratively by continuing to adjust the MVs and evaluating the reward function 274 using the predicted CVs from predictor model 232m until the reward function 274 has been sufficiently optimized. The optimization process executed by optimizer 278 can be performed subject to various constraints on any MVs, CVs, DVs, or any other variables monitored by main controller 256.

Another new component of main controller 256 in the mesh optimizer embodiment of FIG. 10 is the reward function adjuster 276. Reward function adjuster 276 can be configured to adjust the reward function 274 used by optimizer 278 and/or make other adjustments to the optimization process performed by optimizer 278 based on the online or offline status of each of subsystems 252. For example, reward function adjuster 276 is shown receiving an indication of which subsystems 252 are offline from offline detector 270. In the example scenario shown in FIG. 10, subsystem A 252a is offline, whereas subsystem B 252b and subsystem C 252c are online. In this scenario, offline detector 270 may provide reward function adjuster 276 with an “A offline” signal indicating that subsystem A 252a is offline.

Reward function adjuster 276 can be configured to identify any variables in reward function 274 that are associated with any offline subsystems 252 and selectively remove such variables from reward function 274 in response to receiving an indication that the corresponding subsystem 252 is offline. For example, consider the following simple reward function 274 which quantifies the total volume of diesel added to diesel pool 134 by diesel hydrotreater subsystem 126, fluid catalytic cracking subsystem 128, and hydrocracking subsystem 130:

$$J = {V}_{HTS} + {V}_{FCC} + {V}_{HC}$$

where V_{HTS} is the volume of diesel added to diesel pool 134 by hydrotreater subsystem 126, V_{FCC} is the volume of diesel added to diesel pool 134 by fluid catalytic cracking subsystem 128, and V_{HC} is the volume of diesel added to diesel pool 134 by hydrocracking subsystem 130. Each of V_{HTS}, V_{FCC}, and V_{HC} may be CVs associated with their respective subsystems 126, 128, and 130.

In response to receiving a signal from offline detector 270 indicating that diesel hydrotreater subsystem 126 is offline, reward function adjuster 276 may remove the variable V_{HTS} from the reward function 274 to produce the following adjusted reward function Ja:

$${J}_{a} = {V}_{FCC} + {V}_{HC}$$

The adjusted reward function Jₐ can then be used by optimizer 278 to determine the optimal values of the other variables that remain in the adjusted reward function Jₐ or otherwise affect the result of the optimization process (e.g., variables that appear in constraints, variables that are adjusted in the optimization process but do not appear in the reward function, etc.). In some embodiments, each of offline detector 270, reward function adjuster 276, reward function 274, and optimizer 278 are components of a predictive controller (e.g., an instance of predictive controllers 236) used by main controller 256 in the mesh optimizer embodiment.

The result of the optimization process is a set of optimal values for the MVs that remain in the optimization process (i.e., after removing the variables associated with any offline subsystems 252) and are adjusted when performing the optimization process. Predictor model 232m may use the optimal values for the MVs to generate predicted values of the CVs that are predicted to result from the optimal values of the MVs. Optimizer 278 can provide the optimal values of the MVs in the optimization process (shown in FIG. 10 as plant MVs) as inputs to subsystem controllers 254 in the form of targets 262. Subsystem controllers 254 can use targets 262 as inputs and adjust the MVs in each subsystem 252 in an effort to drive the CVs in each subsystem to the target values specified by targets 262. In some embodiments, optimizer 278 selectively provides only a subset of the plant MVs (i.e., the subset that correspond to online subsystems 252) to subsystem controllers 254. For example, in the scenario illustrated in FIG. 10, optimizer 278 may provide the plant MVs used as targets 262b for subsystem B controller 254b and targets 262c for subsystem C controller 254c. However, optimizer 278 may abstain from providing targets 262a for subsystem A controller 254a because subsystem 252a is offline, as indicated by the dashed lines in FIG. 10.

A major advantage of the mesh optimizer approach shown in FIG. 10 is the flexibility of main controller 256 to handle missing information regarding the states 264 of subsystems 252. For example, if a given subsystem 252 goes offline, the subsystem 252 may stop providing updated values of the next state 264 to main controller 256 (e.g., plant CVs for the offline subsystem 252). In this scenario, main controller 256 may automatically adjust the reward function 274 or other portions of the optimization process to remove any variables associated with the offline subsystem 252. For example, if subsystem A 252a goes offline, main controller 256 may automatically remove any CVs, MVs, and/or DVs associated with subsystem A 252a from the optimization process and consider only the remaining CVs, MVs, and/or DVs associated with the remaining online subsystems 252b and 252c. Any nodes that lie along broken routes in the mesh/graph representation of control system 200 (indicated by broken lines in FIG. 10) can be automatically excluded and main controller 256 can calculate the optimal control actions without them.

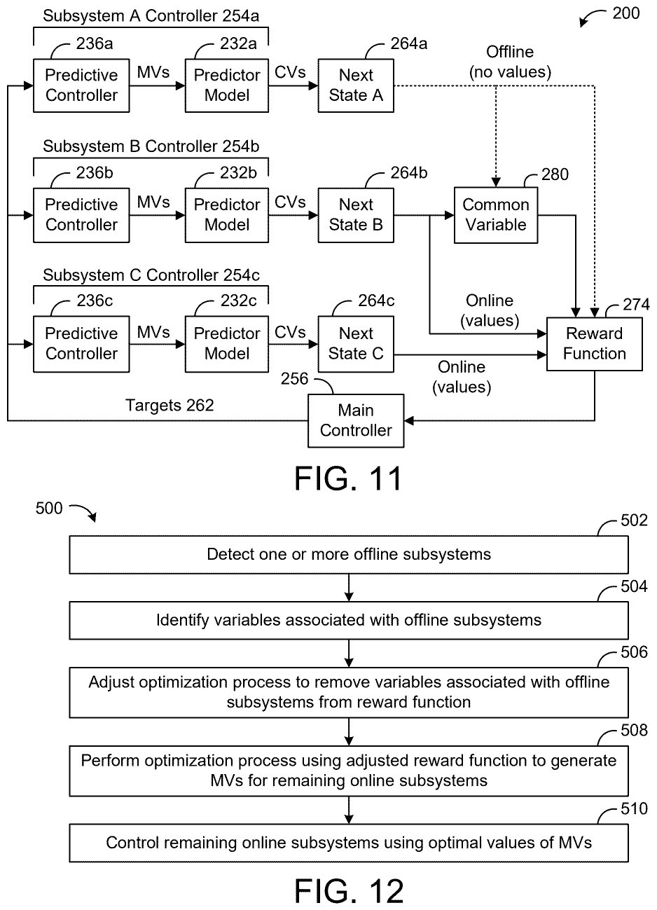

The mesh optimizer embodiment of FIG. 10 allows main controller 256 to be robust to partial control, subsystem shutdowns, and action constraints. This makes the mesh optimizer embodiment immune to several of the challenges noted above with respect to the hierarchical DLPC embodiment of FIGS. 6-9. However, unlike the hierarchical DLPC embodiment, the mesh optimizer embodiment may perform sub-optimally when the reward function 274 includes a common variable 280 based on the states 264 of both online and offline subsystems 252, as shown in FIG. 11. For example, common variable 280 may be an inferential calculated based on both the state 264a of subsystem A 252a and the state 264b of subsystem B 252b. In this scenario, if subsystem A 252a goes offline, the inputs required from subsystem A 252a to calculate the values of common variable 280 (i.e., next state 264a) may be unavailable.

Main controller 256 can handle this scenario by excluding common variable 280 from the reward function 274 or other portions of the optimization process or using the latest values of next state 264a received from subsystem A 252a (i.e., the most recent values of next state 264a before subsystem A 252a went offline) to calculate common variable 280. Additionally or alternatively, if two or more of subsystems 252 have the same function (e.g., multiple parallel instances of distillation subsystem 120, or multiple instances of other subsystems 126-132), main controller 256 can substitute the values of the next state 264 for the online subsystem 252 for the values of the next state for the offline subsystem 252 in reward function 274. For example, if subsystem A 252a and subsystem C 252c perform the same function, main controller 256 can adapt the reward function to substitute the values of next state 264c for the values of next state 264a in reward function 274 and/or in the calculation of common variable 280. This allows common variable 280 to be calculated along with other variables in reward function 274 even if subsystem A 252a goes offline.

Referring now to FIG. 12, a flowchart illustrating a process 500 which can be performed by control system 200 to adapt to offline subsystems 252 is shown, according to an exemplary embodiment. Process 500 can be performed by the components of control system 200 shown in FIGS. 10-11. Process 500 is shown to include detecting one or more offline subsystems (step 502). In some embodiments, step 502 is performed by offline detector 270 as described with reference to FIG. 10. For example, offline detector 270 may receive a signal from one or more of subsystem controllers 254 indicating their corresponding subsystems 252 are offline.

Process 500 is shown to include identifying variables associated with the offline subsystems (step 504) and adjusting the optimization process to remove variables associated with offline subsystems from the reward function (step 506). These steps can be performed by reward function adjuster 276 of main controller 256 as described with reference to FIG. 10. The variables associated with the offline subsystems 252 can include any MVs, CVs, and/or DVs used to control the offline subsystems 252 or affected by operating the offline subsystems 252. In some embodiments, step 506 includes removing the identified variables from both the reward function 274 and other portions of the optimization process (e.g., any constraints, models, equations, etc.) that use the identified variables. The result of steps 504 and 506 is an optimization process which has been adapted to exclude any variables associated with the offline subsystems 252.

Process 500 is shown to include performing the optimization process using the adjusted reward function to generate MVs for the remaining online subsystems (step 508). In some embodiments, step 508 is performed by optimizer 278 of main controller 256 as described with reference to FIG. 10. Step 508 may include performing an optimization of the adjusted reward function to calculate values for the MVs, CVs, and/or DVs that remain in the adjusted reward function or are otherwise used by the adjusted optimization process. Step 508 may include providing the optimal values of the MVs (i.e., the plant MVs shown in FIG. 10) as inputs to the subsystem controllers 254 associated with the online subsystems 252, while abstaining from providing any values of MVs associated with the offline subsystems 252 to their respective subsystem controllers 254.

Process 500 is shown to include controlling the remaining online subsystems using the optimal values of the MVs (step 510). The optimal values of the MVs may be the plant MVs shown in FIG. 10, which may be provided to each of subsystems 252 in the form of targets 262. The targets 262 may define target values for the CVs controlled by each of subsystems 252. Subsystem controllers 254 may use targets 262 to control the equipment of their respective subsystems 252 in an effort to drive the CVs of each subsystem 252 toward the values of targets 262 provided by main controller 256. In some embodiments, step 510 includes subsystem controllers 254 adjusting or operating equipment of the remaining online subsystems 252 in an effort to achieve the targets 262 provided by main controller 256.

### Flex MVs

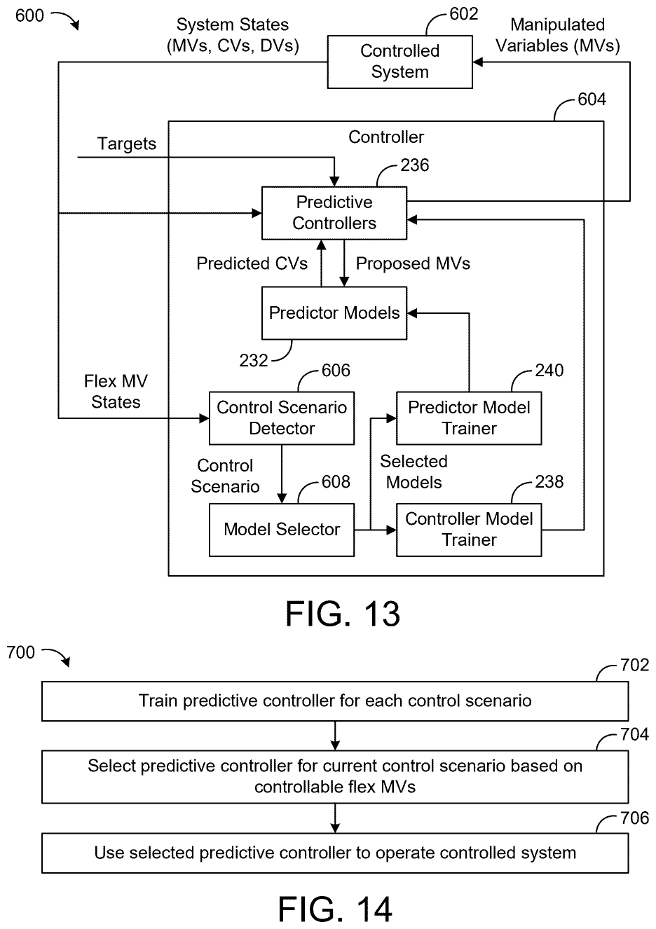

Referring now to FIG. 13, a block diagram of a control system 600 is shown, according to an exemplary embodiment. Control system 600 may be a portion of control system 200 as described with reference to FIGS. 2-12 (e.g., a portion of a modular control system) and is shown to include many of the same components. For example, control system 600 is shown to include a controller 604 and a controlled system 602. Controller 604 can include main controller 256 or any of subsystem controllers 254. Controlled system 602 can include any of the controllable systems or processes controlled by main controller 256 or subsystem controllers 254. Alternatively, control system 600 can be implemented as a non-modular control system and does not require multiple cascaded controllers or other modular components.

If controller 604 is implemented as main controller 256, controlled system 602 may include one or more of subsystems 252 and the corresponding subsystem controllers 254. In an implementation of controller 604 as main controller 256, controller 604 may receive a set of targets (e.g., plant targets 268 shown in FIG. 6) and generate a set of MVs (e.g., plant MVs or subsystem targets 262 shown in FIG. 6) for controlled system 602. Controller 604 may provide the MVs to controlled system 602 (e.g., to subsystem controllers 254) for use as target values of the CVs controlled by each of subsystem controllers 254, as described with reference to FIGS. 2-11.

Alternatively, if controller 604 is implemented as one of subsystem controllers 254, controlled system 602 may include the corresponding subsystem 252 and equipment thereof. In an implementation of controller 604 as one of subsystem controllers 254, controller 604 may receive a set of targets (e.g., subsystem targets 262) from main controller 256 and generate a set of MVs (e.g., subsystem MVs shown in FIG. 5) for controlled system 602. Controller 604 may provide the MVs to controlled system 602 (e.g., to subsystems 252) for use in controlling the various equipment and devices of each subsystem 252, as described with reference to FIGS. 2-11.

Controller 604 is shown to include many of the same components previously described. For example, controller 604 is shown to include predictor models 232, predictive controllers 236, predictor model trainer 240, and controller model trainer 238. These components may be the same as or similar to the like-numbered components described with reference to FIGS. 2-12. The remaining components of controller 604 (i.e., control scenario detector 606 and model selector 608) may be specialized components configured to handle the flex MV scenario described with reference to FIG. 13. In some embodiments, controller 604, controlled system 602, and the flex MV concepts can be used in combination with the modular control systems and methods described throughout the present disclosure. However, it is contemplated that the components of system 600 and the flex MV concepts are not limited to use in modular control systems, but rather are more generally applicable to other types of control systems as well. It is contemplated that the flex MV concepts described with reference to FIG. 13 can be implemented in any type of control system regardless of modularity.

In control system 600, certain MVs generated by controller 604 can sometimes become uncontrollable due to external or manual interventions, effectively turning such MVs into DVs. MVs that transition between being controllable and uncontrollable are referred to as “flex MVs.” As described herein, a flex MV is a variable which functions as a MV when it is controllable but functions as a DV when it becomes uncontrollable. When a flex MV becomes uncontrollable, controller 604 may be aware of the current values of the flex MV, but cannot adjust the flex MV directly. This scenario presents a challenge for controller 604, where the inability to control certain MVs can limit operational flexibility. Despite having access to the values of the uncontrollable flex MVs, controller 604 is unable to use them for optimization. To address this, controller 604 is shown to include several additional components including control scenario detector 606, model selector 608, controller model trainer 238, and predictor model trainer 240.

Control scenario detector 606 can be configured to detect which of the flex MVs provided as inputs to controlled system 602 are controllable and uncontrollable. Controllable flex MVs may include any of the flex MVs which can be directly adjusted by controller 604 to affect the operation of controlled system 602, as described with reference to FIG. 2. Uncontrollable flex MVs may include variables that are ordinarily controllable MVs but have become uncontrollable for any of a variety of reasons. For example, an uncontrollable flex MV generated by one of subsystem controllers 254 may be a MV for a specific device of the subsystem 252 controlled by that subsystem controller 254 which has become non-responsive and can no longer be controlled by the subsystem controller 254. As another example, an uncontrollable flex MV generated by main controller 256 may be a plant MV or target 262 for one of subsystems 252 which has gone offline and can no longer be controlled by main controller 256. Such uncontrollable flex MVs may function more like DVs in that they cannot be adjusted or controlled by controller 604.

In some embodiments, control scenario detector 606 receives an indication of which flex MVs are controllable and uncontrollable from controlled system 602, shown as “flex MV states” in FIG. 13. For example, controlled system 602 may provide a signal to controller 604 indicting which of the MVs adjusted by controller 604 are controllable and uncontrollable at various times. In some embodiments, each of the flex MVs has a corresponding flag which can be set to active or inactive (e.g., by controlled system 602) depending on which of the flex MVs are controllable and uncontrollable. Alternatively, control scenario detector 606 can deduce or determine which of the flex MVs are controllable and uncontrollable based on the system state received from controlled system 602. For example, the system state may include a window (e.g., a time series) of values of the MVs, CVs, and/or DVs of controlled system 602. If the values of certain MVs in the system state do not change (e.g., are stuck at fixed values) for more than a threshold amount of time or are inconsistent with the values of the MV specified by controller 604, control scenario detector 606 may determine that the MVs have become uncontrollable. It is contemplated that control scenario detector 606 can use any of a variety of techniques to determine which MVs are controllable and uncontrollable and can provide an indication of the controllable MVs to model selector 608.

As one example, consider an embodiment of control system 600 in which the MVs generated by controller 604 include three MVs: MV1, MV2, and MV3. MV1 and MV2 may transition between being controllable and uncontrollable and thus may be considered flex MVs. MV3 may always be controllable and is considered a standard MV (i.e., not a flex MV). Accordingly, control scenario detector 606 may generate the following four control scenarios based on which of the flex MVs are controllable or uncontrollable:
Scenario 1: MV1 controllable, MV2 controllable, MV3 controllable,
Scenario 2: MV1 controllable, MV2 uncontrollable, MV3 controllable,
Scenario 3: MV1 uncontrollable, MV2 controllable, MV3 controllable, and
Scenario 4: MV1 uncontrollable, MV2 uncontrollable, MV3 controllable.
   It should be understood that this set of control scenarios is merely one example in a simple scenario with two flex MVs. The number of control scenarios increases exponentially with the number of flex MVs following a 2ⁿ pattern where n is the number of flex MVs. Control scenario detector 606 can be configured to detect or generate any number of control scenarios based on the number of flex MVs present in system 600 and whether each of the flex MVs is currently controllable or uncontrollable.

Model selector 608 can be configured to select one or more of predictor models 232 and/or predictive controllers 236 based on the particular control scenario determined by control scenario detector 606 (i.e., based on which of the flex MVs are controllable or uncontrollable). In some embodiments, predictive controllers 236 include multiple predictive controllers 236, each trained for a different control scenario, or may include a single predictive controller 236 trained for all control scenarios. Similarly, predictor models 232 may include multiple predictor models 232, each trained for a different control scenario, or may include a single predictor model 232 trained for all control scenarios. Model selector 608 can be configured to determine the current or applicable control scenario input from control scenario detector 606 and select an instance of predictor models 232 and predictive controllers 236 for the control scenario.

Controller model trainer 238 and predictor model trainer 240 may receive an indication of the selected models from model selector 608 and may execute the model training processes described with reference to FIGS. 2-4 to train the selected instances of predictor models 232 and predictive controllers 236. Each instance of predictive controllers 236 may correspond to one or more of the control scenarios and can be configured to adjust the controllable MVs in the corresponding control scenario(s). For example, for the four control scenarios outlined above, predictive controllers 236 may include a first predictive controller 236 configured to adjust all three of MV1, MV2, and MV3 (i.e., for control scenario #1), a second predictive controller 236 configured to adjust MV1 and MV3, but treat MV2 as a DV (i.e., for control scenario #2), a third predictive controller 236 configured to adjust MV2 and MV3, but treat MV1 as a DV (i.e., for control scenario #3), and a fourth predictive controller 236 configured to adjust only MV3, but treat MV1 and MV2 as DVs (i.e., for control scenario #4). In some embodiments, a single instance of predictive controllers 236 can be used for all control scenarios and trained to operate in multiple different modes depending on which of the flex MVs are controllable or uncontrollable. Accordingly, the different instances of predictive controllers 236 described with reference to the flex MVs embodiment should be understood as encompassing both (i) discrete instances of predictive controllers 236 each trained to handle a different control scenario and/or (ii) a single instance of predictive controllers 236 trained to handle all control scenarios and capable of switching between different operating modes based on which of the control scenarios is selected. Similarly, each instance of predictor models 232 may correspond to one of the control scenarios or a single instance of predictor models 232 can be used for all of the control scenarios.

Each instance of predictive controllers 236 may be trained to handle a corresponding control scenario and configured to adjust only the controllable MVs in that control scenario (i.e., the standard (non-flex) MVs and any controllable flex MVs). Any uncontrollable flex MVs in a given control scenario can be treated as DVs by the corresponding predictive controller 236. Advantageously, this functionality allows controller 604 to handle any control scenario which may arise based on the flex MVs, including those with a limited subset of controllable MVs. During training, controller model trainer 238 may train a different instance of predictive controller 236 for each control scenario, which enables controller 604 to operate efficiently in cases where only a subset of the MVs are available for manipulation. During online operation of system 600, model selector 608 can be configured to select the appropriate instance of predictive controllers 236 based on the current control scenario (i.e., based on which of the flex MVs are controllable or uncontrollable). Controller 604 can then use the selected predictive controller 236 to generate the values of the controllable MVs in that control scenario and provide the values of the MVs as inputs to controlled system 602.

Referring now to FIG. 14, a flowchart of a process 700 for using flex MVs to train and select an appropriate controller model is shown, according to an exemplary embodiment. Process 700 can be performed by one or more components of control system 600, as described with reference to FIG. 13. For example, process 700 can be performed by controller 604, which may include main controller 256 or any of subsystem controllers 254 in various embodiments. The particular MVs used in process 700 may be the MVs capable of being manipulated by whichever controller executes process 700 (i.e., the plant MVs if controller 604 is main controller 256 or the MVs for each subsystem 252 if controller 604 is one of subsystem controllers 254).

Process 700 is shown to include training a predictive controller for each control scenario (step 702). Step 702 may be performed by controller model trainer 238 and may train multiple instances of predictive controllers 236. Each instance of predictive controllers 236 may correspond to a particular control scenario defined by which of the flex MVs are controllable and uncontrollable. Step 702 may include training a different instance of predictive controllers 236 for each control scenario. Each instance of predictive controllers 236 may be configured to adjust only the MVs which are controllable MVs in that control scenario and may treat any other flex MVs which are not controllable in that control scenario as DVs. Alternatively, step 702 may include training a single instance of predictive controllers 236 configured to handle all control scenarios. Such a predictive controller 236 can be implemented, for example, as a neural network with inputs (e.g., flags) that indicate which of the control scenarios is active. In some embodiments, step 702 includes training a different instance of predictor models 232 for each control scenario, or alternatively a single predictor model 232 can be trained for all control scenarios.

Process 700 is shown to include selecting a predictive controller for the current control scenario based on the controllable flex MVs (step 704). In some embodiments, step 704 is performed by control scenario detector 606 and model selector 608 as described with reference to FIG. 13. Step 704 may include detecting which of the flex MVs capable of being adjusted by controller 604 are currently controllable and uncontrollable and identifying the control scenario corresponding to the detected set of controllable flex MVs. The detected set of controllable MVs can then be used to select a particular instance of predictive controllers 236 which corresponds to the identified control scenario.

Process 700 is shown to include using the selected predictive controller to operate the controlled system (step 706). Step 706 may include using the particular instance of predictive controllers 236 selected in step 704 to generate a set of MVs for the controllable MVs in the corresponding control scenario. Any flex MVs which are identified as uncontrollable MVs in the corresponding control scenarios may be treated as DVs and not adjusted by controller 604 in step 706. Step 706 may include providing the values of the MVs for the controllable flex MVs and any other controllable MVs to controlled system 602 for use in operating the equipment thereof. For embodiments, in which controller 604 is main controller 256, the values of the MVs generated by main controller 256 may be used as targets by subsystem controllers 254. For embodiments in which controller 604 is one of subsystem controllers 254, the values of the MVs generated by the subsystem controller 256 can be provided as inputs to equipment of the corresponding subsystem 252 and used to operate the equipment.

### Wind-Up

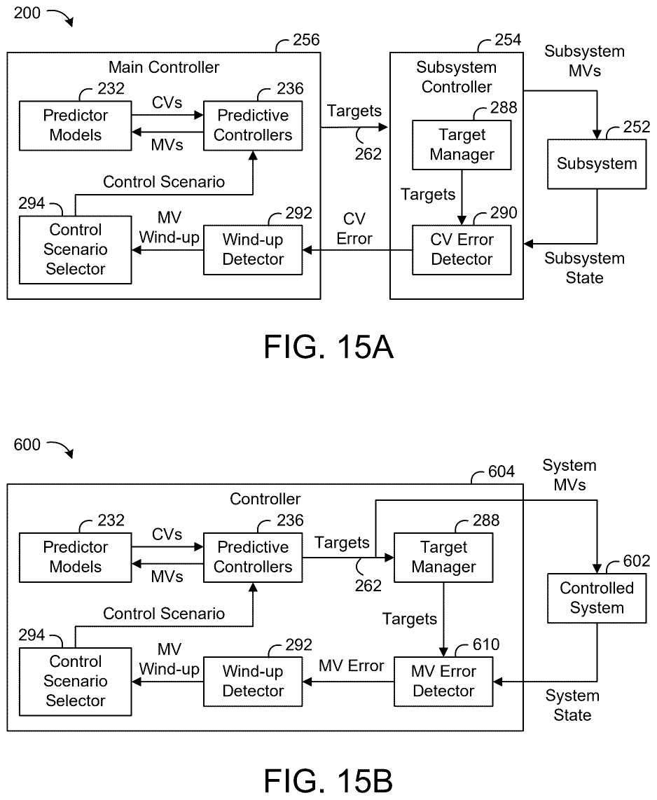

Referring now to FIG. 15A, a block diagram illustrating a portion of control system 200 in greater detail is shown, according to an exemplary embodiment. Control system 200 is shown to include many of the same components previously described including main controller 256 and a subsystem controller 254. In the embodiment of FIG. 15A, subsystem controller 254 may be any of the subsystem controllers 254 previously described (e.g., subsystem A controller 254a, subsystem B controller 254b, subsystem C controller 254c, etc.). Subsystem controller 254 can be configured to monitor and control a corresponding subsystem 252, which may be any of the subsystems 252 previously described (e.g., (e.g., subsystem A 252a, subsystem B 252b, subsystem C 252c, etc.).

In the embodiment of FIG. 15A, main controller 256 and subsystem controller 254 may include any or all of the components or functionality of controllers 254-256 previously described with reference to FIGS. 2-14. For example, main controller 256 is shown to include predictor models 232 and predictive controllers 236. Although not shown in FIG. 15A, subsystem controller 254 may also include instances of predictor models 232 and predictive controllers 236 as previously described. Subsystem controller 254 and main controller 256 are also shown to include several new components configured to handle a wind-up scenario, described in detail below. Although the wind-up scenario is described primarily in the context of modular control systems throughout the present disclosure for ease of explanation, it should be understood that wind-up is not exclusive to modular control systems and can occur in other types of control systems as well. It is contemplated that the wind-up concepts described herein are not limited to use in modular control systems, but rather can be implemented in any type of control system regardless of modularity.

Wind-up is a phenomenon which occurs in control systems when certain MVs reach their limits and therefore cannot be moved any further in a given direction. For example, a MV such as the position of a flow control valve may be considered wound-up when the valve reaches a fully open position and cannot be opened any further. Some wind-up conditions are the result of the physical capabilities of the controlled equipment or system, whereas other wind-up conditions are the result of constraints imposed on the equipment or system which prevents actuation beyond prescribed limits. Wind-up can occur in both the MVs adjusted by subsystem controllers 254 and the MVs adjusted by main controller 256. Wind-up in a MV adjusted by a subsystem controller 254 may occur when that MV cannot reach the target for the MV provided by subsystem controller 254. Similarly, wind-up in a MV adjusted by main controller 256 may occur when that MV (which may be a CV in subsystems 252) cannot reach the target for the MV provided by main controller 256.

In the context of control system 200, wind-up may occur when certain CVs in subsystem 252 fail to reach their targets, which may occur for any of a variety of reasons. For example, some CVs in subsystem 252 may be limited by physical capabilities of subsystem 252, constraints imposed on the operation of subsystem 252, bounds on the MVs of subsystem 252 which are adjusted to control the values of the CVs, and/or wind-up in the MVs of subsystem 252. These and other conditions in subsystem 252 can prevent subsystem controller 254 from achieving its goal (e.g., causing a CV in subsystem 252 to reach a target provided by main controller 256) and impedes the ability of subsystem controller 254 to enact desired control actions. The failure of subsystem controller 254 to drive the CVs in subsystem 252 to their targets also affects main controller 256 because some of the CVs in subsystem 252 may be MVs from the perspective of main controller 256. For example, consider a scenario in which a CV in subsystem 252 cannot be moved further in a given direction due to any of the constraints or limitations of subsystem 252 noted above. Main controller 256 may see this scenario as wind-up in the corresponding MV which main controller 256 uses to provide a target for the CV in subsystem 252 because that MV is effectively wound-up from the perspective of main controller 256. Accordingly, when a CV of subsystem controller 254 cannot reach the target provided by main controller 256, the corresponding MV adjusted by main controller 256 can be considered wound-up. This makes it difficult for main controller 256 to control effectively and limits the optimization capability of main controller 256, as result of main controller 256 being unable to use its full range of controls efficiently.

In some embodiments such as the hierarchical DLPC embodiment of FIGS. 6-9, wind-up is especially problematic because the instances of predictor models 232 within main controller 256 treat the various subsystems 252 and their respective subsystem controllers 254 as PIDs or other feedback control loops which operate to achieve the values of the targets 262 provided as MVs by main controller 256. However, when certain CVs in subsystems 252 cannot be moved further in a given direction, subsystem controllers 254 may fail to achieve the targets 262 provided by main controller 256. Accordingly, main controller 256 continuing to increase or decrease the targets 262 (i.e., MVs adjusted by main controller 256) may have no effect on subsystems 252 once the corresponding CV of subsystem 252 has reached its limit. This problem may be exacerbated in embodiments when predictive controllers 236 are implemented as neural networks.

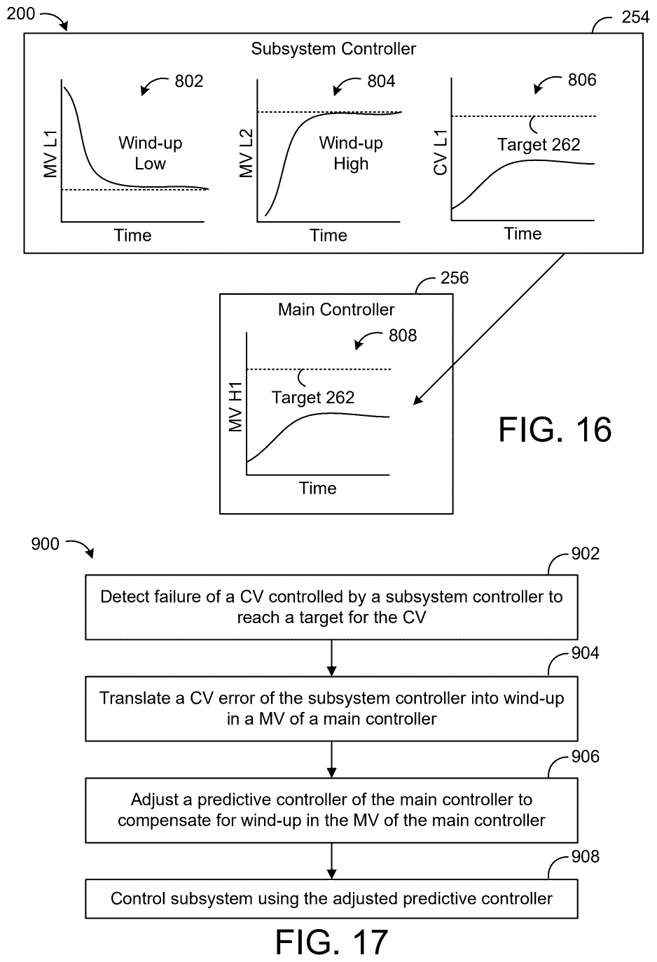

One example of wind-up occurring in control system 200 is illustrated in FIG. 16, which includes several graphs 802-808 showing time series of various MVs and CVs used by main controller 256 and subsystem controller 254. In this example, subsystem controller 254 adjusts two MVs, shown as MV L1 in graph 802 and MV L2 in graph 804. The solid lines in graphs 802 and 804 indicate the actual values of MV L1 and MV L2 respectively, whereas the dashed lines in graphs 802 and 804 indicate the values at which MV L1 and MV L2 are wound-up. Graph 806 illustrates the values of a CV controlled by subsystem controller 254, shown as CV L1. The solid line in graph 806 indicates the actual value of CV L1, whereas the dashed line in graph 806 indicates the target 262 for CV L1 provided by main controller 256. The wind-up of MV L1 and MV L2 causes CV L1 to fall short of its target 262.

Graph 808 illustrates the values of a MV adjusted by main controller 256, shown as MV H1. The solid line in graph 808 indicates the actual value of MV H1, whereas the dashed line in graph 808 indicates the target 262 for MV H1 provided by main controller 256. In this example, the variable represented by MV H1 is a MV from the perspective of main controller 256 but a CV (i.e., CV L1) from the perspective of subsystem controller 254. Accordingly, when wind-up occurs in subsystem 252, the value of CV L1 cannot be increased further and falls short of target 262 in graph 806. This translates to MV H1 falling short of target 262 in graph 808. Without appropriate compensation for wind-up, main controller 256 may seek to continue increasing the value of MV H1 in an effort to drive the value of CV L1 toward its target 262. However, control system 200 can be configured to actively identify and compensate for wind-up conditions as described in detail below.

Referring again to FIG. 15A, subsystem controller 254 is shown to include a target manager 288 and a CV error detector 290. Target manager 288 can be configured to store and manage the targets that apply to the CVs managed by subsystem controller 254 (i.e., the CVs of subsystem 252). Such targets may include the targets 262 provided by main controller 256 for the various CVs controlled by subsystem controller 254. Target manager 288 may provide the targets as input to CV error detector 290.

CV error detector 290 can be configured to detect when certain CVs controlled by subsystem controller 254 fail to reach their targets. CV error detector 290 may receive the targets from target manager 288 and may receive the state of subsystem 252 (shown as the subsystem state in FIG. 15A) as input from subsystem 252. The subsystem state may include the current or predicted values of the MVs, CVs, and/or DVs of subsystem 252. CV error detector 290 may compare the targets provided by target manager 288 to the subsystem state to determine whether any of the CVs of subsystem 252 are failing to reach their respective targets. For example, CV error detector 290 may determine that a CV of subsystem 252 has failed to reach its target if the CV cannot be increased above a maximum value which is less than the target provided by main controller 256 or cannot be decreased below a minimum value that is more than the target provided by main controller 256. In some embodiments, CV error detector 290 determines whether the CV of subsystem 252 has failed to reach its target by monitoring the actual value of the CV in response to changes in the target value of the CV. For example, if the actual value of the CV of subsystem 252 does not change in response to increasing or decreasing the target value of the CV beyond a certain value, CV error detector 290 may determine that the CV has become stuck at that actual value and cannot be increased or decreased any further. In some embodiments, CV error detector 290 determines whether the CV of subsystem 252 is at a low limit value or a high limit value. A low limit value may be a value at which the CV cannot be decreased further, whereas a high limit value may be a value at which the CV cannot be increased further.

CV error detector 290 may provide an indication that the CV of subsystem 252 has failed to reach its target to main controller 256, shown as “CV error” in FIG. 15A. In some embodiments, CV error detector 290 also provides an indication of whether the CV of subsystem 252 is stuck at a low limit or a high limit. In some embodiments, the CV error indication is provided in the form of an input flag (e.g., CV error=yes, CV limit high=yes, CV limit low=yes) from subsystem controller 254 to main controller 256. In some embodiments, the CV error indication provided by CV error detector 290 indicates that a CV of subsystem 252 is unable to reach its target as a result of wind-up in a corresponding MV of subsystem 252 which is used to affect the CV. In other embodiments, the CV error indication may specify any other reason (if known) why the CV of subsystem 252 is unable to reach its target (e.g., CV has reached a physical or logical constraint, etc.). Main controller 256 can be configured to use the CV error indication to make adjustments to the control process executed by main controller 256.

Still referring to FIG. 15A, main controller 256 is shown to include a wind-up detector 292 and a control scenario selector 294. Wind-up detector 292 may be configured to receive the CV error indication from subsystem controller 254 and translate the CV error indication into a MV wind-up indication for a corresponding MV of main controller 256, shown as “MV wind-up” in FIG. 15A. For example, as noted above, some of the CVs managed by subsystem controller 254 may be MVs from the perspective of main controller 256. If a given CV of subsystem controller 254 is unable to reach the target specified by the corresponding MV of main controller 256, the MV of main controller 256 can be considered effectively wound-up. Wind-up detector 292 can be configured to identify the MV of main controller 256 which corresponds to the CV of subsystem controller 254 which is unable to reach its target and generate a MV wind-up indication for the corresponding MV of main controller 256. In some embodiments, wind-up detector 292 also provides an indication of whether the wound-up MV of main controller 256 is a low wind-up or a high wind-up. Wind-up detector 292 may provide an indication of the wound-up MV of main controller 256 and/or the corresponding CV of subsystem controller 254 to control scenario selector 294.

Control scenario selector 294 may be configured to adjust the operation of predictive controllers 236 in response to receiving a wind-up indication from wind-up detector 292. As described above, the instances of predictor models 232 within main controller 256 may be configured to predict the CVs of subsystems 252 that will result from given control actions or targets 262 provided by main controller 256. Under some conditions when a CV of subsystem 252 is able to reach the targets 262 provided by main controller 256, adjusting the value of targets 262 will cause the CV of subsystem 252 to increase or decrease toward the new value of targets 262. However, under other conditions, the same adjustment to targets 262 may not cause a change in the CV of subsystem 252 because the CV of subsystem 252 cannot be increased or decreased further.

Control scenario selector 294 may be configured to select a control scenario for predictive controllers 236 based on the wound-up MV of main controller 256 and/or the corresponding CV of subsystem controller 254 which cannot reach its target, as reported by wind-up detector 292. In some embodiments, control scenario selector 294 causes predictive controllers 236 to switch between different instances of predictive controllers 236 (e.g., different controller neural networks), based on which of the MVs adjusted by predictive controllers 236 are wound-up. Each of the different instances of predictive controllers 236 may be trained for a different control scenario as described with reference to FIGS. 13-14. For example, if a given MV adjusted by predictive controllers 236 is wound-up, control scenario selector 294 may cause predictive controllers 236 to treat the wound-up MV as an uncontrollable flex MV and use an instance of predictive controllers 236 trained for a control scenario in which that MV is an uncontrollable flex MV. However, the wound-up MV may only be uncontrollable in one direction (i.e., above a maximum wind-up limit or below a minimum wind-up limit) and can still be adjusted in the other direction. Alternatively, a single instance of predictive controllers 236 can be used for all scenarios (i.e., regardless of which of the MVs adjusted by predictive controllers 236 are wound-up) and configured to operate in a particular mode based on the control scenario selected by control scenario selector 294. For example, the selected control scenario may cause predictive controllers 236 to prevent any wound-up MVs from being increased or decreased beyond their respective wind-up limits.

In some embodiments, the control scenario selected by control scenario selector 294 causes predictive controllers 236 to maintain the values of any MVs generated by predictive controllers 236 within wind-up limits for the MVs. The wind-up limits for the MVs can be provided as known inputs to main controller 256 or automatically determined by main controller 256 by monitoring the actual values of the MVs adjusted by main controller 256 relative to the targets 262. If the actual value of a MV adjusted by main controller 256 does not move in response to a change in the target value of the MV beyond a certain value, main controller 256 may determine the MV is wound-up at that value. In some embodiments, control scenario selector 294 causes predictive controllers 236 to abstain from adjusting a wound-up MV above the maximum wind-up limit or below the minimum wind-up limit for the MV. For example, if a given MV is already at its maximum wind-up limit, control scenario selector 294 may prevent predictive controllers 236 from increasing the MV above the maximum wind-up limit. Similarly, if a given MV is already at its minimum wind-up limit, control scenario selector 294 may prevent predictive controllers 236 from decreasing the MV below the minimum wind-up limit. Control scenario selector 294 may impose constraints on the values of the MVs generated by predictive controllers 236 based on the wind-up limits and may prevent predictive controllers 236 from generating values of the MVs that violate the constraints.

Advantageously, the inputs provided by control scenario selector 294 to predictive controllers 236 enables main controller 256 to adapt to scenarios in which certain MVs become uncontrollable due to wind-up conditions. When such scenarios occur, main controller 256 can switch to a control strategy (e.g., a different instance of predictive controllers 236, additional constraints on predictive controllers 236) that uses the remaining non-wound-up MVs of main controller 256 to affect the values of the CVs of subsystems 252 (e.g., any CVs of subsystems 252 which can still be controlled) while preventing the wound-up MVs from being adjusted beyond their wind-up limits. Accordingly, main controller 256 may learn to compensate for wind-up conditions by adjusting the non-wound-up MVs of main controller 256 to affect the values of the CVs in subsystem 252. This allows the CVs of subsystem 252 to remain controllable in the event that wind-up occurs in one or more of the MVs of main controller 256 by shifting to a control strategy that adjusts other non-wound-up MVs instead of the wound-up MVs.

Referring now to FIG. 15B, another embodiment of control system 600 is shown. Control system 600 may be a portion of control system 200 as described with reference to FIGS. 2-16 (e.g., a portion of a modular control system) or may be a separate control system (e.g., a non-modular control system) separate from control system 200. Control system 600 is shown to include many of the same components as control system 200 in FIG. 15A and control system 600 shown in FIG. 13. For example, control system 600 is shown to include a controller 604 and a controlled system 602. Controller 604 can include main controller 256, any of subsystem controllers 254, or a separate controller configured to control a non-modular system. Controlled system 602 can include any of the controllable systems or processes controlled by main controller 256, subsystem controllers 254, or a non-modular control system. In some embodiments, controller 604 and controlled system 602 may include some or all of the same components or functionality as described with reference to FIG. 13.

Controller 604 is shown to include many of the same components as main controller 256 and subsystem controller 254 in FIG. 15A (e.g., predictor models 232, predictive controllers 236, target manager 288, control scenario selector 294, and wind-up detector 292), which may operate in the same or similar manner as described with reference to FIG. 15A. However, FIG. 15B shows all of these components within a single controller 604 rather than being distributed across multiple modular controllers 254 and 256 as shown in FIG. 15A. Controller 604 is also shown to include a MV error detector 610, which may function in a similar manner as CV error detector 290 of FIG. 15A, but with respect to the MVs of controlled system 602 rather than the CVs of subsystem 252, as described below.

In operation, controller 604 may provide targets 262 to controlled system 602. The targets 262 may include target values for the MVs of controlled system 602 and are shown as “system MVs” in FIG. 15B. Controlled system 602 may use the system MVs as inputs to operate equipment of controlled system 602. The system state of controlled system 602 (e.g., MVs, CVs, DVs, etc.) can be provided as a feedback from controlled system 602 to controller 604. MV error detector 610 can be configured to compare the actual values of the MVs included in the system state of controlled system 602 to the targets 262 for the MVs provided by controller 604. MV error detector 610 may determine whether any of the MVs of controlled system 602 have failed to reach their targets 262 and may provide an output to wind-up detector 292 (shown as “MV error” in FIG. 15B) indicating whether any of the MVs of controlled system 602 have failed to reach the targets 262 provided by controller 604. Wind-up detector 292 may determine that one or more of the MVs of controlled system 602 are wound-up in response to the MV error indicating that such MVs have failed to reach their targets. The remaining components of controller 604 may operate in the same or similar manner as their like-numbered components in FIG. 15A.

Referring now to FIG. 17, a flowchart of a process 900 for compensating for wind-up in one or more MVs is shown, according to an exemplary embodiment. Process 900 can be performed by one or more components of control system 200, as described with reference to FIGS. 15-16. For example, process 900 can be performed by one or more components of main controller 256 or any of subsystem controllers 254 in various embodiments.

Process 900 is shown to include detecting failure of a CV controlled by a subsystem controller to reach a target for the CV (step 902). In some embodiments, step 902 is performed by CV error detector 290 as described with reference to FIG. 15A. The subsystem can include any of subsystems 252, whereas the subsystem controller can include any of subsystem controllers 254. Step 902 may include comparing the values of the CVs defined by the state of subsystem 252 to target values of the CVs to determine whether any of the CVs are have failed to reach their targets. In some embodiments, step 902 includes comparing the actual values of the CVs of subsystem 252 to the target values of the CVs provided by main controller 256 to determine whether any of the CVs are unable to reach their targets.

In some embodiments, step 902 includes determining a gradient or relationship between a CV of subsystem 252 and a MV adjusted to affect the CV. If the gradient is substantially flat (e.g., substantially zero) or the relationship indicates that the CV is no longer responsive to further changes in the values of the MV (e.g., the CV of subsystem 252 is unable to reach its target), step 902 may determine that the CV of subsystem 252 is stuck or cannot be increased or decreased further. In some embodiments, step 902 includes providing an indication of the CV error of subsystem 252 and an indication of whether the CV error is a low CV error (i.e., the CV cannot be decreased further) or a high CV error (i.e., the CV cannot be increased further). In some embodiments, the CV error indication provided in step 902 indicates that a CV of subsystem 252 is unable to reach its target as a result of wind-up in the MV of subsystem 252 which is used to affect the CV or any other reason or condition in subsystem 252 that may prevent the CV from reaching its target.

Process 900 is shown to include translating the CV error in the CV of the subsystem controller to wind-up in a MV of the main controller (step 904). In some embodiment, step 904 is performed by wind-up detector 292 as described with reference to FIG. 15A. Step 904 may include identifying the MV of main controller 256 which corresponds to the CV of subsystem controller 254 which is unable to reach its target. For example, if the CV of subsystem controller 254 which is unable to reach its target is controlled to a target value provided by main controller 256, step 904 may include identifying the MV of main controller 256 that provides the target value. Such a relationship between the CVs of subsystem controller 254 and the MVs of main controller 256 is shown in FIG. 16.

Process 900 is shown to include adjusting a predictive controller of the main controller to compensate for wind-up in the MV of the main controller (step 906). In some embodiments, step 906 is performed by control scenario selector 294 as described with reference to FIG. 15A. Step 906 may include adjusting one or more of predictive controllers 236 within main controller 256 to maintain the values of any MVs generated by predictive controllers 236 within wind-up limits for the MVs. In some embodiments, step 906 includes causing predictive controllers 236 to abstain from adjusting a wound-up MV above a maximum wind-up limit or below the minimum wind-up limit for the MV. In some embodiments, step 906 includes imposing constraints on the values of the MVs generated by predictive controllers 236 based on the wind-up limits to prevent predictive controllers 236 from generating values of the MVs that violate the constraints. In some embodiments, step 906 includes causing predictive controllers 236 to switch between different instances or modes of predictive controllers 236 (e.g., different controller neural networks, different operating modes, etc.), based on which of the MVs adjusted by predictive controllers 236 are wound-up. Each of the different instances or modes of predictive controllers 236 may be trained for a different control scenario, as described with reference to FIGS. 13-14, and may treat the wound-up MVs as uncontrollable flex MVs.

Process 900 is shown to include controlling the subsystem using the adjusted predictive controller (step 908). Step 908 may be performed by main controller 256 and/or subsystem controller 254 as described with reference to FIG. 15A. Step 908 may include using the adjusted predictive controllers 236 generated in step 906 to generate targets 262 as MV outputs of main controller 256. Targets 262 can be provided as inputs to subsystem controllers 254 and used by subsystem controllers 254 as goals or setpoints for one or more CVs controlled by subsystem controllers 254. Step 908 may include using subsystem controllers 254 to adjust one or more MVs of subsystems 252 in an effort to drive the CVs of subsystems 252 toward the targets 262 provided by main controller 256. Step 908 may include operating various equipment of subsystems 252 using the values of the MVs generated by subsystem controllers 254 to affect a variable state or condition of subsystems 252 represented by the CVs of subsystems 252.

### Modular Control Adaptation Process

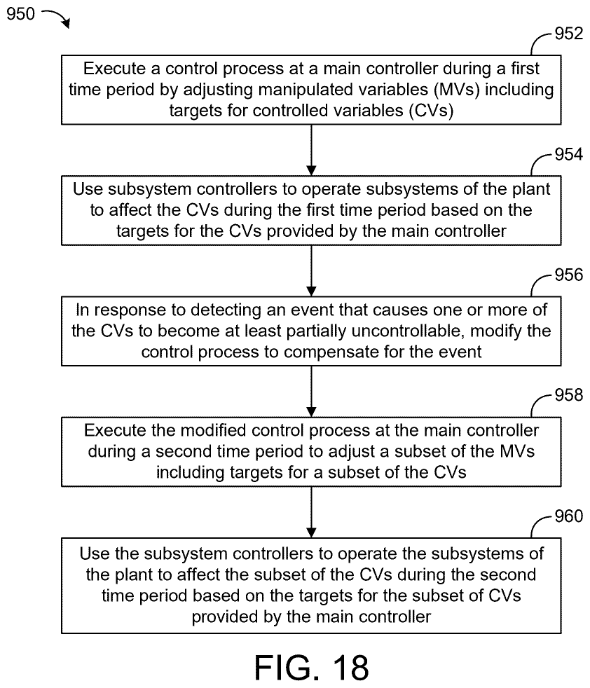

Referring now to FIG. 18, a flowchart of a process 950 for adapting a modular control system or modular control process to compensate for various events is shown, according to an exemplary embodiment. Process 950 can be performed by one or more components of control system 200 and/or control system 600 as described with reference to FIGS. 2-17. For example, process 950 can be performed by main controller 256, one or more of subsystem controllers 254, controller 604, or any components thereof using any of the techniques previously described. In some embodiments, process 950 can be implemented or applied in oil refinery system 100 to monitor and control the various subsystems 120-132 of oil refinery system 100. However, it is contemplated that process 950 is not limited to oil refinery system 100 and can be applied to any other type of controllable system or process which includes multiple interconnected subsystems.

Process 950 is shown to include executing a control process at a main controller during a first time period by adjusting manipulated variables (MVs) including targets for controlled variables (CVs) (step 952). Step 952 can be performed by main controller 256 as described with reference to FIGS. 2-17. The control process in step 952 may include a high level control process executed by main controller 256 to generate values of the MVs provided to subsystem controllers 254. The MVs generated by main controller 256 may include targets (e.g., goals, setpoints, etc.) for various CVs affected by operating subsystems 252. The MVs adjusted in step 952 may include a plurality of MVs which are provided as inputs to a plurality of subsystem controllers 254. Each of the MVs may correspond to a particular CV controlled by subsystem controllers 254 and may include a target value for the corresponding CV.

In some embodiments, the control process executed in step 952 is a hierarchical DLPC process as described with reference to FIGS. 6-9. For example, the control process in step 952 may include using a deep learning controller of main controller 256 (e.g., an instance of predictive controllers 236m shown in FIG. 8) to generate adjusted values for the MVs as outputs of a controller neural network. The control process in step 952 may further include using a deep learning predictor of main controller 256 (e.g., an instance of predictor models 232m shown in FIG. 8) to predict values of the CVs predicted to result from the adjusted values of the MVs as outputs of a predictor neural network.

In some embodiments, the control process executed in step 952 is a mesh optimizer control process as described with reference to FIGS. 10-12. For example, the control process in step 952 may include using an optimization-based controller of main controller 256 (e.g., optimizer 278 shown in FIG. 10) to generate adjusted values of the MVs by performing an optimization of a reward function 274 based on predicted values of the CVs. The control process in step 952 may further include using a predictor model of main controller 256 (e.g., predictor model 232m shown in FIG. 10) to generate the predicted values of the CVs predicted to result from the adjusted values of the MVs.

Process 950 is shown to include using subsystem controllers to operate subsystems of the plant to affect the CVs during the first time period based on the targets for the CVs provided by the main controller (step 954). Step 954 may be performed by one or more of subsystem controllers 254 to operate subsystems 252 of plant 210. Step 954 may include using subsystem controllers 254 to generate subsystem MVs as shown in FIG. 5, which may include control signals for various equipment of subsystems 252. In some embodiments, subsystem controllers 254 function as low level PIDs or feedback control loops in the context of the modular control system and operate their respective subsystems 252 in an effort to drive the CVs of each subsystem 252 toward the targets provided by main controller 256.

In some embodiments, each of subsystem controllers 254 is implemented as a deep learning process controller (DLPC) including an instance of predictive controllers 236 and an instance of predictor models 232, as shown in FIG. 5. Step 954 may include each subsystem controller 254 using corresponding a deep learning controller (e.g., an instance of predictive controllers 236) to generate control signals for equipment of the corresponding subsystem 252 as outputs of a controller neural network based on the targets provided by main controller 256. Step 954 may further include each subsystem controller 254 using a corresponding deep learning predictor (e.g., an instance of predictor models 232) to predict values of one or more of the CVs as outputs of a predictor neural network based on the control signals generated by the deep learning controller.

Process 950 is shown to include, in response to detecting an event that causes one or more of the CVs to become at least partially uncontrollable, modifying the control process to compensate for the event (step 956). In some embodiments, the event detected in step 956 includes a shutdown of one or more of subsystems 252. In this context, a shutdown may include any of subsystems 252 going offline, becoming non-responsive, encountering an error that halts the operation of the subsystem 252, losing connection to main controller 256 or its corresponding subsystem controller 254, or otherwise becoming inoperable or uncontrollable either fully or partially. The one or more CVs that become at least partially uncontrollable in step 956 may include any of the CVs affected by the shutdown subsystems 252. In some embodiments, detecting the event that causes one or more of the CVs to become at least partially uncontrollable includes receiving an indication or signal from subsystem controllers 254 or from an operator that the corresponding subsystems 252 are offline or otherwise uncontrollable. In various embodiments, the detection in step 956 may include main controller 256 automatically detecting or inferring that one or more of subsystems 252 are offline or otherwise uncontrollable (e.g., based on whether subsystems 252 or subsystem controllers 254 respond to the control inputs from main controller 256) or may include main controller 256 receiving an explicit signal or flag (e.g., from subsystem controllers 254, subsystems 252, an operator, an external system or device, etc.) that one or more of subsystems 252 are offline or otherwise uncontrollable.

In some embodiments, modifying the control process in step 956 includes causing main controller 256 to change operating modes or otherwise switch to a different control strategy to compensate for the event. For example, main controller 256 may change from (i) using a first model trained with historical values of the CVs, MVs, and/or DVs associated with all of subsystems 252 to (ii) using a second model trained with historical values of only a subset of the CVs, MVs, and/or DVs associated with a subset of subsystems 252 excluding the one or more subsystems for which the shutdown is detected. The first and second models may be different instances of predictive controllers 236m or predictor models 232m used by main controller 256, as shown in FIG. 8. In some embodiments, each instance of predictive controllers 236m and predictor models 232m is trained to handle a different control scenario in which only a subset of subsystems 252 are online and operational. Accordingly, when one or more of subsystems 252 go offline, main controller 256 may switch to using the corresponding predictive controller 236m and/or predictor model 232m trained to handle (e.g., using only data from) that combination of online/offline subsystems 252. In some embodiments, the first and second models may be the same model operated in different modes. For example, the first and second models may be the same neural network model (e.g., an instance of predictive controllers 236m or predictor models 232m) which is trained using a flag to indicate the particular control scenario for each training episode. When that control scenario arises during online operation, the same flag can be provided as an input to the model to cause it to operate in a mode corresponding to that scenario.

In some embodiments, modifying the control process in step 956 includes modifying an optimization process performed by main controller 256 (e.g., in the mesh optimizer embodiment of FIG. 10) to generate adjusted values of the MVs. For example, step 956 may include removing the one or more CVs which have become at least partially uncontrollable from a reward function evaluated by main controller 256 when performing the optimization process, one or more models used by main controller 256 when performing the optimization process, and/or one or more constraints on the optimization process evaluated by main controller 256 when performing the optimization process. In some embodiments, modifying the control process in step 956 also removes other variables (e.g., MVs, DVs, other CVs, etc.) associated with the offline or uncontrollable subsystems 252 from the control process in addition to the one or more CVs which have become at least partially uncontrollable.

In some embodiments, modifying the control process in step 956 includes adjusting the control process based on flex MVs, as described with reference to FIGS. 13-14. For example, the MVs adjusted by main controller 256 may include one or more flex MVs that transition between being controllable by main controller 256 and uncontrollable by main controller 256. The event that causes the one or more CVs to become at least partially uncontrollable may include a transition into a control scenario in which one or more of the flex MVs become uncontrollable by main controller 256. In response to detecting that one or more of the flex MVs have become controllable, step 956 may include modifying the control process to cause main controller 256 to stop using the one or more uncontrollable flex MVs to control the one or more CVs.

In some embodiments, main controller 256 may include multiple instances of predictive controllers 236. Each instance predictive controllers 236 may be trained to handle a different control scenario in which different subsets of the flex MVs are controllable and uncontrollable. Modifying the control process in step 956 may include causing main controller 256 to change from (i) using a first predictive controller (e.g., a first instance of predictive controllers 236) trained to handle a first control scenario in which a first subset of the flex MVs are controllable to (ii) using a second predictive controller (e.g., a second instance of predictive controllers 236) trained to handle a second control scenario in which a second subset of the flex MVs are controllable. In some embodiments, modifying the control process in step 956 does not affect predictor models 232.

In some embodiments, the event that causes the one or more CVs to become at least partially uncontrollable in step 956 includes wind-up in the CVs, as described with reference to FIGS. 15-17. For example, physical limitations, constraints, operational limits, or other factors affecting subsystems 252 may prevent certain CVs controlled by subsystem controllers 254 from increasing above a maximum value (referred to herein as a “maximum wind-up limit”) or decreasing below a minimum value (referred to herein as a “minimum wind-up limit”). Accordingly, wind-up in the CVs controlled by subsystem controllers 254 may prevent the CVs from being increased above a maximum CV wind-up limit or decreased below a minimum CV wind-up limit.

Because the CVs controlled by subsystem controllers 254 correspond to certain MVs controlled by main controller 256, wind-up in the CVs may correspond to the MVs also being wound-up. For example, if a given MV adjusted by main controller 256 includes a target value for a corresponding CV which has reached its wind-up limit, the MV may also be considered wound-up. Step 956 may include translating the wind-up in the one or more CVs into wind-up in one or more corresponding MVs that include targets for the one or more CVs. Modifying the control process in step 956 may include preventing the one or more corresponding MVs from being increased above a maximum MV wind-up limit or decreased below a minimum MV wind-up limit. Step 956 may include imposing constraints on the wound-up MV, removing the wound-up MV from the control process, and/or switching to a control strategy that uses other MVs which are not yet at their wind-up limits to control the operation of subplants 252.

Process 950 is shown to include executing the modified control process at the main controller during a second time period to adjust a subset of the MVs including targets for a subset of the CVs (step 958). Step 958 may be the same as or similar to step 952 with the exception that main controller 256 executes the modified control process created in step 956 instead of the original control process executed in step 952. The modified control process in step 958 may include adjusting only a subset of the MVs instead of the full set of MVs adjusted in step 952. The subset of MVs may include, for example, only the MVs associated with the remaining online subsystems 252, only the MVs or flex MVs which remain controllable, and/or only the MVs which have not yet reached their wind-up limits. The subset of MVs adjusted in step 958 may include targets for a corresponding subset of the CVs.

Process 950 is shown to include using the subsystem controllers to operate the subsystems of the plant to affect the subset of the CVs during the second time period based on the targets for the subset of CVs provided by the main controller (step 960). Step 960 may be the same as or similar to step 954 with the exception that subsystem controllers 254 use only the subset of MVs generated in step 958 instead of the full set of MVs generated in step 952 to control the operation of their corresponding subsystems 252. The subset of CVs affected in step 960 may include, for example, only the CVs associated with the remaining online subsystems 252, only the CVs which remain controllable, and/or only the CVs which have not yet reached their wind-up limits. The subset of CVs affected in step 960 may include the CVs for which targets are provided in step 958.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A modular control system for a plant comprising a plurality of interconnected subsystems, the modular control system comprising:
a plurality of subsystem predictive controllers configured to operate corresponding subsystems of the plurality of interconnected subsystems to affect a plurality of controlled variables (CVs); and
a main controller configured to:
execute a control process comprising adjusting a plurality of manipulated variables (MVs) comprising targets for the plurality of CVs and providing the plurality of MVs as inputs to the plurality of subsystem predictive controllers during a first time period;
in response to detecting an event that causes one or more CVs of the plurality of CVs to become at least partially uncontrollable, modify the control process to compensate for the event; and
execute the modified control process comprising adjusting a subset of MVs of the plurality of MVs and providing the subset of MVs as inputs to the plurality of subsystem predictive controllers during a second time period;
wherein the plurality of subsystem predictive controllers are configured to operate the plurality of interconnected subsystems to affect at least a subset of CVs of the plurality of CVs during the second time period based on targets for the subset of CVs provided by the subset of MVs.

2. The modular control system of claim 1, wherein the main controller comprises a deep learning predictor configured to generate values of the plurality of CVs predicted to result from the adjusted values of the plurality of MVs using a predictor neural network.

3. The modular control system of claim 1, wherein:
the event that causes the one or more CVs to become at least partially uncontrollable is a shutdown of one or more subsystems of the plurality of interconnected subsystems that operate to affect the one or more CVs; and
modifying the control process comprises causing the main controller to change from:
using a first model trained with historical values of the plurality of CVs and the plurality of MVs associated with all of the plurality of interconnected subsystems; to
using a second model trained with historical values of the subset of CVs and the subset of MVs associated with a subset of the plurality of interconnected subsystems excluding the one or more subsystems for which the shutdown is detected.

4. The modular control system of claim 1, wherein each of the plurality of subsystem predictive controllers corresponds to one of the plurality of interconnected subsystems and comprises a deep learning predictor configured to predict values of one or more of the plurality of CVs associated with the corresponding subsystem using a predictor neural network based on the control signals generated by the deep learning controller.

5. The modular control system of claim 1, wherein the main controller comprises:
an optimization-based controller configured to generate adjusted values of the plurality of MVs by performing an optimization of a reward function based on predicted values of the plurality of CVs; and
a predictor model configured to generate the predicted values of the plurality of CVs predicted to result from the adjusted values of the plurality of MVs.

6. The modular control system of claim 1, each of the plurality of subsystem predictive controllers corresponds to one of the plurality of interconnected subsystems and comprises:
an optimization-based controller configured to generate adjusted values of a plurality of MVs of the corresponding subsystem by performing an optimization of a reward function based on predicted values of the plurality of CVs; and
a predictor model configured to generate the predicted values of the plurality of CVs predicted to result from the adjusted values of the plurality of MVs of the corresponding subsystem.

7. The modular control system of claim 1, wherein modifying the control process comprises modifying an optimization process performed by the main controller to generate adjusted values of the plurality of MVs;
wherein modifying the optimization process comprises removing the one or more CVs which have become at least partially uncontrollable from at least one of:
a reward function evaluated by the main controller when performing the optimization process;
one or more models used by the main controller when performing the optimization process; or
one or more constraints on the optimization process evaluated by the main controller when performing the optimization process.

8. The modular control system of claim 1, wherein:
detecting the event that causes the one or more CVs to become at least partially uncontrollable comprises detecting a failure of the one or more CVs to reach one or more targets for the CVs provided by the main controller, the failure preventing the one or more CVs from being increased above a maximum CV limit or decreased below a minimum CV limit;
the main controller is configured to translate the failure of the one or more CVs to reach the one or more targets into wind-up in one or more corresponding MVs of the main controller that comprise the one or more targets for the one or more CVs of the plurality of interconnected subsystems; and
modifying the control process comprises preventing the one or more corresponding MVs of the main controller from being increased above a maximum MV wind-up limit or decreased below a minimum MV wind-up limit.

9. A method for operating a modular control system for a plant comprising a plurality of interconnected subsystems, the method comprising:
executing a control process at a main controller during a first time period, the control process comprising adjusting a plurality of manipulated variables (MVs) comprising targets for a plurality of controlled variables (CVs);
using a plurality of subsystem predictive controllers to operate the plurality of interconnected subsystems to affect the plurality of CVs during the first time period based on the targets for the plurality of CVs provided by the main controller;
in response to detecting an event that causes one or more CVs of the plurality of CVs to become at least partially uncontrollable, modifying the control process to compensate for the event;
executing the modified control process at the main controller during a second time period, the modified control process comprising adjusting a subset of MVs of the plurality of MVs comprising targets for a subset of CVs of the plurality of CVs;
using the plurality of subsystem predictive controllers to operate the plurality of interconnected subsystems to affect at least the subset of CVs during the second time period based on the targets for the subset of CVs provided by the main controller.

10. The method of claim 9, wherein executing the control process or the modified control process at the main controller comprises using a deep learning predictor of the main controller to generate values of the plurality of CVs predicted to result from the adjusted values of the plurality of MVs using a predictor neural network.

11. The method of claim 9, wherein:
the event that causes the one or more CVs to become at least partially uncontrollable is a shutdown of one or more subsystems of the plurality of interconnected subsystems that operate to affect the one or more CVs; and
modifying the control process comprises causing the main controller to change from:
using a first model trained with historical values of the plurality of CVs and the plurality of MVs associated with all of the plurality of interconnected subsystems; to
using a second model trained with historical values of the subset of CVs and the subset of MVs associated with a subset of the plurality of interconnected subsystems excluding the one or more subsystems for which the shutdown is detected.

12. The method of claim 9, wherein using the plurality of subsystem predictive controllers to operate the plurality of interconnected subsystems comprises using a deep learning predictor of the plurality of subsystem predictive controllers to predict values of one or more of the plurality of CVs using a predictor neural network based on the control signals generated by the deep learning controller.

13. The method of claim 9, wherein executing the control process or the modified control process at the main controller comprises:
using an optimization-based controller of the main controller to generate adjusted values of the plurality of MVs by performing an optimization of a reward function based on predicted values of the plurality of CVs; and
using a predictor model of the main controller to generate the predicted values of the plurality of CVs predicted to result from the adjusted values of the plurality of MVs.

14. The method of claim 9, wherein using the plurality of subsystem predictive controllers to operate the plurality of interconnected subsystems comprises:
using an optimization-based controller of the plurality of subsystem predictive controllers to generate adjusted values of a plurality of MVs of a corresponding subsystem by performing an optimization of a reward function based on predicted values of the plurality of CVs; and
using a predictor model of the plurality of subsystem predictive controllers to generate the predicted values of the plurality of CVs predicted to result from the adjusted values of the plurality of MVs of the corresponding subsystem.

15. The method of claim 9, wherein modifying the control process comprises modifying an optimization process performed by the main controller to generate adjusted values of the plurality of MVs;
wherein modifying the optimization process comprises removing the one or more CVs which have become at least partially uncontrollable from at least one of:
a reward function evaluated by the main controller when performing the optimization process;
one or more models used by the main controller when performing the optimization process; or
one or more constraints on the optimization process evaluated by the main controller when performing the optimization process.

16. The method of claim 9, wherein:
detecting the event that causes the one or more CVs to become at least partially uncontrollable comprises detecting a failure of the one or more CVs to reach one or more targets for the CVs provided by the main controller, the failure preventing the one or more CVs from being increased above a maximum CV limit or decreased below a minimum CV limit;
the method comprises translating the failure of the one or more CVs to reach the one or more targets into wind-up in one or more corresponding MVs of the main controller that comprise the one or more targets for the one or more CVs of the plurality of interconnected subsystems; and
modifying the control process comprises preventing the one or more corresponding MVs of the main controller from being increased above a maximum MV wind-up limit or decreased below a minimum MV wind-up limit.

17. A predictive controller for a plant, the predictive controller comprising one or more processors and one or more non-transitory computer-readable media storing instructions that, when executed by the one or more processors, cause the one or more processors to perform operations comprising:
executing a predictive control process comprising adjusting a plurality of manipulated variables (MVs) comprising targets for equipment of the plant and providing the plurality of MVs as inputs to the equipment of the plant during a first time period;
in response to detecting an event that causes one or more MVs of the plurality of MVs to become at least partially uncontrollable, modifying the predictive control process to compensate for the event; and
executing the modified predictive control process comprising adjusting a subset of MVs of the plurality of MVs and providing the subset of MVs as inputs to the equipment of the plant during a second time period;
wherein the equipment of the plant operate to affect a plurality of controlled variables (CVs) of the plant during the second time period based on the targets provided by the plurality of MVs.

18. The predictive controller of claim 17, wherein:
the plurality of MVs comprise one or more flex MVs that transition between being controllable and uncontrollable;
the event that causes the one or more MVs to become at least partially uncontrollable is a transition into a control scenario in which the one or more flex MVs are uncontrollable; and
modifying the predictive control process comprises causing the predictive controller to stop using the one or more flex MVs to control the plurality of CVs in response to detecting that the one or more flex MVs have become uncontrollable.

19. The predictive controller of claim 17, wherein:
the plurality of MVs comprise one or more flex MVs that transition between being controllable and uncontrollable;
the predictive controller comprises a plurality of predictive controllers or a plurality of operating modes trained to handle a plurality of different control scenarios in which different subsets of the flex MVs are controllable and uncontrollable; and
modifying the predictive control process comprises causing the predictive controller to change from (i) using a first predictive controller or first operating mode trained to handle a first control scenario in which a first subset of the flex MVs are controllable to (ii) using a second predictive controller or second operating mode trained to handle a second control scenario in which a second subset of the flex MVs are controllable.

20. The predictive controller of claim 17, wherein:
the event that causes the one or more MVs to become at least partially uncontrollable comprises wind-up in the one or more MVs; and
modifying the predictive control process comprises preventing the one or more MVs from being increased above a maximum MV wind-up limit or decreased below a minimum MV wind-up limit.
